(19) United States
(12) Patent Application Publication
(10) Pub. No.: US 2026/0065616 A1
(43) Pub. Date: Mar. 5, 2026

(54) MODIFYING DIGITAL IMAGES VIA PERSPECTIVE-AWARE TEXT EDITING

(71) Applicant: Adobe Inc., San Jose, CA (US)

(72) Inventors: Rishav Agarwal, Howrah (IN); Ronak Mehta, UDAIPUR (IN); Nitin Sharma, Gurugram (IN); Apurva Kumar, Patna (IN)

(21) Appl. No.: 18/825,654

(22) Filed: Sep. 5, 2024

(51) Int. Cl. G06T 19/20; G06T 5/77; G06T 7/50; G06T 11/60; G06T 15/04; G06T 15/20; G06T 17/20; G06V 30/14

(52) U.S. Cl. CPC G06T 19/20; G06T 5/77; G06T 7/50; G06T 11/60; G06T 15/04; G06T 15/20; G06T 17/20; G06V 30/1444; G06T 2207/20081; G06T 2207/20084; G06T 2210/12; G06T 2219/2004; G06T 2219/2016

(57) ABSTRACT

The present disclosure relates to systems, non-transitory computer-readable media, and methods for generating an editable text object that follows a depth perspective of a digital image from a text segment portrayed according to the depth perspective. In particular, in some cases, the disclosed systems detect a text segment portrayed in accordance with a depth perspective of a digital image displayed by a client device. Further, the disclosed systems generate, within the digital image and from the text segment, an editable text object that follows the depth perspective of the digital image. Additionally, the disclosed systems modify the editable text object in accordance with the depth perspective of the digital image in response to receiving one or more user interactions via the client device.

### BACKGROUND

Recent years have seen significant improvements in hardware and software platforms for editing content within digital images. Indeed, as the use of digital images has become increasingly ubiquitous, systems have developed to facilitate the manipulation of the content within such digital images. Some platforms, for example, offer tools for creating editable text from otherwise non-editable text in digital images. Further, some of these platforms enable the creation of editable text from otherwise non-editable text that is portrayed in a three-dimensional perspective. Despite these advancements, conventional image editing systems typically fail to maintain the three-dimensional perspective of a text when creating the corresponding editable text, leading to inaccurate editing results that require numerous user interactions and computer resources to correct.

### SUMMARY

Embodiments of the present disclosure provide benefits and/or solve one or more of the foregoing or other problems in the art with systems, non-transitory computer-readable media, and methods for generating, from a text segment of a digital image, an editable text object that follows a three-dimensional depth perspective of the digital image. To illustrate, in one or more embodiments, the disclosed systems detect text segments in a digital image. Further, the disclosed systems infer the three-dimensional structure of the digital image, such as by creating a three-dimensional mesh from the image. Using the three-dimensional mesh, the disclosed systems flatten a targeted text segment into a two-dimensional representation, generate a text object having live text from the flattened result, and re-map the text object—including edits to the text therein—back to the three-dimensional structure. Thus, in these or other embodiments, the disclosed systems flexibly edit the text of a digital image portraying a depth perspective while accurately maintaining the depth perspective with reduced user input.

Additional features and advantages of one or more embodiments of the present disclosure are outlined in the description which follows and are determined at least in part from the description or learned by the practice of such example embodiments.

### BRIEF DESCRIPTION OF THE DRAWINGS

The detailed description provides one or more embodiments with additional specificity and detail through the use of the accompanying drawings, as briefly described below.

FIG. 1 illustrates an example system environment in which a depth perspective-aware editing system operates in accordance with one or more embodiments.

FIG. 2 illustrates the depth perspective-aware editing system generating and modifying an editable text object according to a depth perspective in accordance with one or more embodiments.

FIG. 3 illustrates the depth perspective-aware editing system detecting text segments of the digital image in accordance with one or more embodiments.

FIG. 4 illustrates the depth perspective-aware editing system generating a three-dimensional mesh structure of the digital image in accordance with one or more embodiments.

FIGS. 5A-5B illustrates the depth perspective-aware editing system generating a two-dimensional representation of a text region of a digital image having a targeted text segment in accordance with one or more embodiments.

FIG. 6 illustrates the depth perspective-aware editing system generating an editable text object of a text segment in accordance with one or more embodiments.

FIG. 7 illustrates the depth perspective-aware editing system modifying the editable text object and projecting the modified editable text object into three-dimensions in accordance with one or more embodiments.

FIG. 8 illustrates the depth perspective-aware editing system displaying the modified editable text object in a second region of the digital image according to the depth perspective of the second region in accordance with one or more embodiments.

FIG. 9 illustrates an example schematic diagram of the depth perspective-aware editing system in accordance with one or more embodiments.

FIG. 10 illustrates a flowchart of a series of acts for generating a modified editable text object that follows a depth perspective of a digital image from a text segment portrayed according to the depth perspective in accordance with one or more embodiments.

FIG. 11 illustrates a block diagram of an example computing device for implementing one or more embodiments of the present disclosure.

### DETAILED DESCRIPTION

This disclosure describes one or more embodiments of a depth perspective-aware editing system that efficiently uses reduced user input to modify a text object created from a digital image while accurately maintaining the depth perspective of the digital image. Indeed, in some embodiments, the depth perspective-aware editing system generates, from a text segment of a digital image (e.g., a raster image), an editable text object that follows a depth perspective of the digital image. For example, in some cases, the depth perspective-aware editing system flattens the text segment by projecting the text segment onto a two-dimensional surface. From the projected text segment, the depth perspective-aware editing system uses an optical character recognition model to generate the editable text object. Upon modifying the editable text object in response to user interactions, the depth perspective-aware editing system projects the modified text object back onto the underlying three-dimensional structure of the digital image to portray the modified text object in accordance with the depth perspective. In some instances, the depth perspective-aware editing system further performs inpainting to fill in holes that result from the modified text.

As mentioned above, in one or more embodiments, the depth perspective-aware editing system generates an editable text object that follows a (e.g., three-dimensional) depth perspective of a digital image. Indeed, in some embodiments, the depth perspective-aware editing system generates a text object that is modifiable and oriented within a digital image in accordance with its depth perspective. In some cases, the depth perspective-aware editing system modifies the editable text object—such as by modifying its text, color, font, font size, and/or position—while maintaining the depth perspective of the digital image.

In some embodiments, the depth perspective-aware editing system detects a text segment within the digital image for use in generating the editable text object. In some instances, the text segment is portrayed in accordance with the depth perspective of the digital image. For instance, in some cases, the characters of the text segment have one or more visual characteristics (e.g., size and/or orientation) that provide the characters and/or the text segment as a whole with a three-dimensional visual appearance. In certain embodiments, the depth perspective-aware editing system utilizes an object detection model to detect a text region of the digital image containing the text segment.

In one or more embodiments, the depth perspective-aware editing system further determines the three-dimensional structure associated with the depth perspective of the digital. For example, in some embodiments, the depth perspective-aware editing system generates a depth map of the digital image, such as by using a depth detection machine learning model. Moreover, in some embodiments, the depth perspective-aware editing system identifies sample points from the depth map and uses a triangulation model to generate a three-dimensional mesh based on the sample points. In some implementations, the depth perspective-aware editing system combines the digital image as a base texture with the three-dimensional mesh to generate a three-dimensional mesh structure that provides an image-to-mesh mapping.

In one or more embodiments, the depth perspective-aware editing system flattens the text region including the text segment by generating a two-dimensional representation of the text region using the three-dimensional mesh structure. For instance, in some embodiments, the depth perspective-aware editing system utilizes a surface normal detection model to determine surface normals for a portion of the three-dimensional mesh structure corresponding to the text region. The depth perspective-aware editing system further generates a rendered mesh of the digital image using a three-dimensional rendering engine and aligns the text region with a camera view direction of the digital image based on the surface normals. Additionally, in some implementations, the depth perspective-aware editing system uses a reverse texture mapping model to project the text region aligned with the camera view direction onto a two-dimensional surface, thereby generating the two-dimensional representation of the text region.

In one or more embodiments, from the projected text region, the depth perspective-aware editing system generates the editable text object for the text segment. For instance, in some embodiments, the depth perspective-aware editing system uses an optical character recognition model—such as a binarization model—to extract the glyphs from the two-dimensional representation of the text region. In some cases, the depth perspective-aware editing system further uses a neural network to determine a font of the glyphs. Using this information, the depth perspective-aware editing system generates the editable text object.

As noted previously, in one or more implementations, the depth perspective-aware editing system modifies and projects the editable text object in accordance with the depth perspective of the digital image. Specifically, in some cases, the depth perspective-aware editing system modifies the editable text object in response to receiving one or more user interactions via a client device portraying the digital image. Further, in some embodiments, the depth perspective-aware editing system projects the editable text object onto the three-dimensional mesh structure to portray the modified editable text object in accordance with the depth perspective of the digital image. In some implementations, the depth perspective-aware editing system places the modified editable text object in either the same position as the text region within the digital image or repositions the modified editable text object while maintaining the depth perspective of the digital image. Indeed, the depth perspective-aware editing system projects the modified editable text object back onto the digital image in accordance with the respective depth perspective the selected position.

Furthermore, in one or more embodiments, the depth perspective-aware editing system performs to fill pixels initially occupied by the text segment. For example, in certain cases, the depth perspective-aware editing system uses an image completion model to generate one or more content fills for the editable text object. Thus, in cases where modifying the editable text object exposes pixels previously occupied by the corresponding text segment, the depth perspective-aware editing system exposes the content fill(s) within the digital image.

As mentioned above, conventional image editing systems suffer from several technological shortcomings that result in inflexible, inefficient, and inaccurate operation. For example, many conventional systems are inflexible in that they fail to accommodate the three-dimensional structure of a digital image—particularly a digital raster image—when generating live text. Indeed, while some conventional systems enable the creation of editable text from otherwise non-editable text, such systems often fail to create the editable text to portray, adhere to, or otherwise follow a (e.g., three-dimensional) depth perspective of the digital image, even where the corresponding non-editable text follows the depth perspective. Indeed, many of these systems rigidly generate editable text that follows and maintains a flat, two-dimensional perspective. Thus, these systems fail to configure the editable text to conform to the underlying three-dimensional structure upon which the editable text is positioned.

Additionally, conventional image editing systems often fail to operate efficiently. In particular, conventional systems often use inefficient solutions for producing live text from otherwise non-editable text of a digital image and manipulating the live text to have a 3D appearance in accordance with a depth perspective of the digital image. For instance, many conventional systems require a significant number of user interactions with a user interface to implement various tools to create editable text, edit the text, and manually adjust the appearance of the text to be visually consistent with the depth perspective of the digital image. To illustrate, to create editable text with a consistent 3D appearance, conventional systems often require a comprehensive, multi-step process with manual user inputs at each step, including vectorizing the image, selecting the Bezier output from the vectorization to group the text objects, removing the three-dimensional projections to bring the text objects into a flat two-dimensional representation, performing the text editing, and manually re-applying the three-dimensional perspective to the edited text to be consistent with the original location of the non-editable text within the digital image. In many cases, manually re-applying the three-dimensional perspective alone requires a significant number of user interactions for tediously manipulating the appearance of the edited text so it appears to conform with the underlying three-dimensional structure of the digital image. Furthermore, when repositioning edited text to a new location, conventional systems typically require user interactions to manually apply changes in the three-dimensional appearance to be consistent with the new location.

In addition to operating inflexibly and inefficiently, conventional image editing systems also often operate inaccurately. For instance, by failing to accommodate the underlying three-dimensional structure of a digital image when generating live text from non-editable text portrayed therein, conventional systems provide inaccurate editing results. Indeed, by creating live text having a flat orientation, such systems produce editing results that fail to realistically portray edited text within a three-dimensional environment. Even those systems that enable user interactions to manually adjust the appearance of edited text often fail to provide results in which the edited text accurately conforms to the underlying three-dimensional structure as the editing results are prone to user error and lack of knowledge of the underlying structure.

One or more embodiments of the depth perspective-aware editing system provide various advantages relative to conventional systems. For example, one or more embodiments of the depth perspective-aware editing system operate with improved flexibility when compared to conventional systems. Indeed, by generating an editable text object that follows the depth perspective of a digital image, the depth perspective-aware editing system flexibly accommodates the underlying three-dimensional structure of the digital image. For instance, by creating and using a three-dimensional mesh structure for a digital image to flatten a non-editable text segment portrayed therein, create a corresponding editable text object, and re-map the edited text object back to three dimensions, the depth perspective-aware editing system configures the editable text object to conform to the underlying structure of the digital image.

Additionally, one or more embodiments of the depth perspective-aware editing system operate with improved efficiency when compared to conventional systems. For instance, one or more embodiments of the depth perspective-aware editing system reduce the number of user interactions required to create live text that conforms to the three-dimensional structure of a digital image. To illustrate, by performing various behind-the-scenes operations for determining the depth perspective of a digital image, creating a three-dimensional mesh structure based on the depth perspective, and mapping an editable text object to the structure, the depth perspective-aware editing system intelligently configures the editable text object to follow the depth perspective without requiring user interactions for manual adjustments. Indeed, the depth perspective-aware editing system avoids the need for a comprehensive multi-step process that requires manual inputs at each step to access and use various graphical user interface tools, menus, and settings to produce conforming live text. In some instances, the depth perspective-aware editing system creates a conforming editable text object based on a relatively small set of user interactions (e.g., a selection of a menu option or targeted text).

Further, one or more embodiments of the depth perspective-aware editing system operate with improved accuracy when compared to conventional systems. In particular, by generating an editable text object that follows the depth perspective of a digital image, the depth perspective-aware editing system generates editing results with a more realistic appearance. Indeed, the depth perspective-aware editing system generates editing results that accurately portray edited text within a three-dimensional environment.

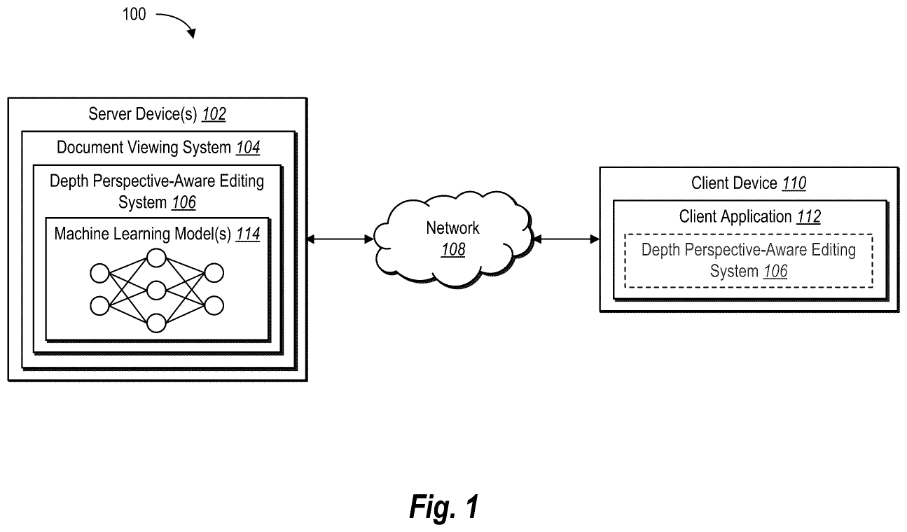

Additional detail regarding the depth perspective-aware editing system will now be provided with reference to the figures. For example, FIG. 1 illustrates a schematic diagram of an exemplary system 100 in which a depth perspective-aware editing system 106 operates. As illustrated in FIG. 1, the system 100 includes a server device(s) 102, a network 108, and a client device 110. Although the system 100 of FIG. 1 is depicted as having a particular number of components, the system 100 is capable of having any number of additional or alternative components (e.g., any number of server devices, client devices, or other components in communication with the depth perspective-aware editing system 106 via the network 108). Similarly, although FIG. 1 illustrates a particular arrangement of the server device(s) 102, the network 108, and the client device 110, various additional arrangements are possible.

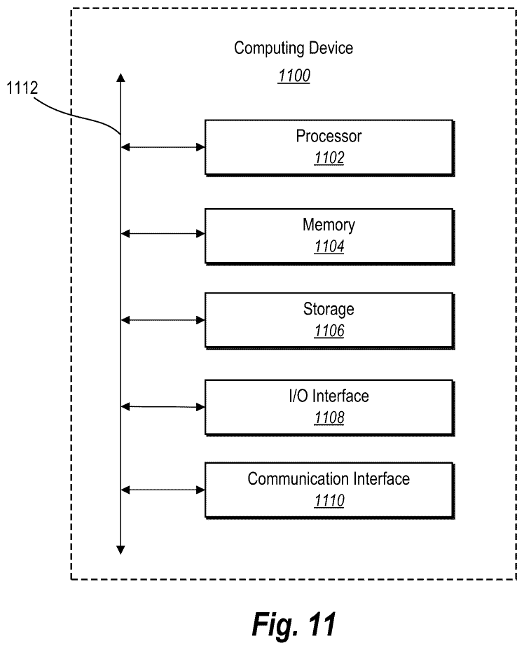

The server device(s) 102, the network 108, and the client device 110 are communicatively coupled with each other either directly or indirectly (e.g., through the network 108 discussed in greater detail below in relation to FIG. 11). Moreover, the server device(s) 102 and the client device 110 include one or more of a variety of computing devices (including one or more computing devices as discussed in greater detail with relation to FIG. 11).

As mentioned above, the system 100 includes the server device(s) 102. In one or more embodiments, the server device(s) 102 generates, stores, receives, and/or transmits data including notifications, models, and digital images. In one or more embodiments, the server device(s) 102 comprises a data server. In some implementations, the server device(s) 102 comprises a communication server or a web-hosting server.

As shown, the server device(s) 102 includes a document viewing system 104. In one or more embodiments, the document viewing system 104 provides functionality by which a client device (e.g., the client device 110) views, generates, stores, and/or edits digital documents, such as digital images. For example, in some instances, a client device sends a digital image to the document viewing system 104 hosted on the server device(s) 102 via the network 108. The document viewing system 104 then provides many options that are usable by the client device to edit the digital image, store the digital image, and subsequently search for, access, and view the digital image. For instance, in some cases, the document viewing system 104 provides one or more options that are usable by the client device to create and edit an editable text object from a text segment portrayed within a digital image.

As further shown, the server device(s) 102 also include the depth perspective-aware editing system 106. In one or more embodiments, the depth perspective-aware editing system 106 modifies text of a digital image in accordance with the depth perspective of the digital image. In particular, as will be explained below, the depth perspective-aware editing system generates and implements an editable text object that follows the depth perspective of the digital image in some embodiments. Thus, as changes are made to the editable text object, the edited text conforms to the underlying three-dimensional structure of the digital image.

As illustrated in FIG. 1, the depth perspective-aware editing system 106 includes a machine learning model(s) 114. Indeed, in these or other embodiments, the depth perspective-aware editing system 106 implements the machine learning model(s) 114 to generate and/or implement an editable text object. In some cases, the machine learning model(s) 114 are external to the depth perspective-aware editing system 106, but the depth perspective-aware editing system 106 nevertheless accesses and utilizes the machine learning model(s) 114 via one or more plugins, APIs, or other network-based access protocols.

In one or more embodiments, the client device 110 includes a computing device that accesses, edits, segments, modifies, stores, and/or provides, for display, digital content such as digital images. For example, in some embodiments, the client device 110 includes a smartphone, a tablet, a desktop computer, a laptop computer, a head-mounted-display device, or another electronic device. In some instances, the client device 110 includes one or more applications (e.g., a client application 112) that access, edit, segment, modify, store, and/or provide, for display, digital content such as digital images. For example, in one or more embodiments, the client application 112 includes a software application installed on the client device 110. Additionally, or alternatively, the client application 112 includes a web browser or other application that accesses a software application hosted on the server device(s) 102 (and supported by the document viewing system 104).

To provide an example implementation, in some embodiments, the depth perspective-aware editing system 106 on the server device(s) 102 supports the depth perspective-aware editing system 106 on the client device 110. For instance, in some cases, the depth perspective-aware editing system 106 on the server device(s) 102 generates or learns parameters for the machine learning model(s) 114. The depth perspective-aware editing system 106 then, via the server device(s) 102, provides the machine learning model(s) 114 to the client device 110. In other words, the client device 110 obtains (e.g., downloads) the machine learning model(s) 114 from the server device(s) 102. Once downloaded, the depth perspective-aware editing system 106 on the client device 110 uses the machine learning model(s) 114 to generate and implement editable text objects that follow the depth perspective of the corresponding digital images independent of the server device(s) 102.

In alternative implementations, the depth perspective-aware editing system 106 includes a web hosting application that allows the client device 110 to interact with content and services hosted on the server device(s) 102. To illustrate, in one or more implementations, the client device 110 accesses a software application supported by the server device(s) 102. The client device 110 provides input to the server device(s) 102, such as a digital image (e.g., a digital raster image) portraying one or more text segments in a depth perspective. In response, the depth perspective-aware editing system 106 on the server device(s) 102 generates an editable text object from one of the text segments according to the depth perspective of the digital image. The server device(s) 102 then provides the digital image with the editable text object to the client device 110 for display.

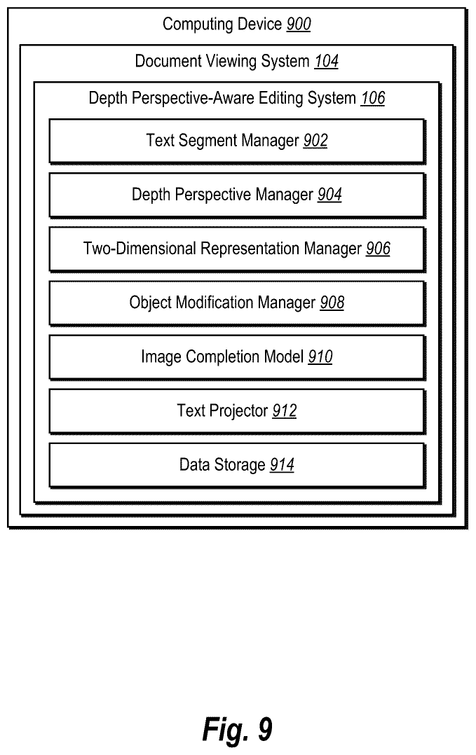

Although FIG. 1 illustrates the depth perspective-aware editing system 106 implemented with regard to the server device(s) 102, different components of the depth perspective-aware editing system 106 are able to be implemented by a variety of devices within the system 100. For example, in some instances, a different computing device (e.g., the client device 110) or a separate server from the server device(s) 102 implements one or more (or all) components of the depth perspective-aware editing system 106. Indeed, as shown in FIG. 1, the client device 110 includes the depth perspective-aware editing system 106. Example components of the depth perspective-aware editing system 106 will be described below with regard to FIG. 9.

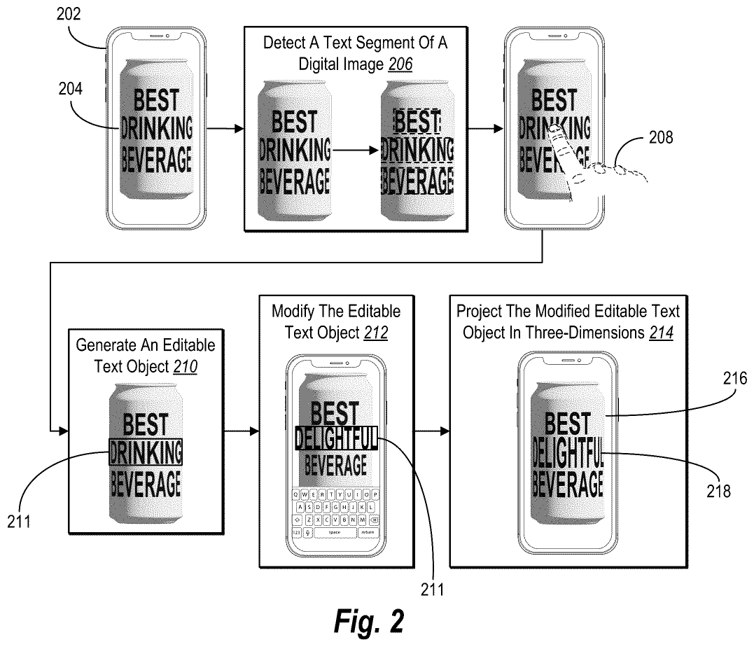

As mentioned, in some embodiments, the depth perspective-aware editing system 106 generates an editable text object that follows a depth perspective of a digital image from a text segment portrayed according to the depth perspective. Further, in some cases, the depth perspective-aware editing system 106 modifies the editable text object in accordance with the depth perspective. FIG. 2 illustrates the depth perspective-aware editing system 106 generating and modifying an editable text object according to a depth perspective of a digital image in accordance with one or more embodiments.

In one or more embodiments, an editable text object includes a text object having editable (i.e., live) text. In particular, in some embodiments, an editable text object includes a text object having editable text from a digital image. In some cases, an editable text object includes a text object having editable text generated from non-editable text of a digital image (e.g., text from a raster digital image). In some instances, the text of an editable text object includes text adjustable for characteristics, such as those including but not limited to font, size, color, content, location, perspective, and/or orientation. While some embodiments create an editable text object from non-editable text, in some cases, an editable text object includes text such as text in vector graphics formats like SVG (Scalable Vector Graphics) or text layers in design software including selectable, editable, and formattable text.

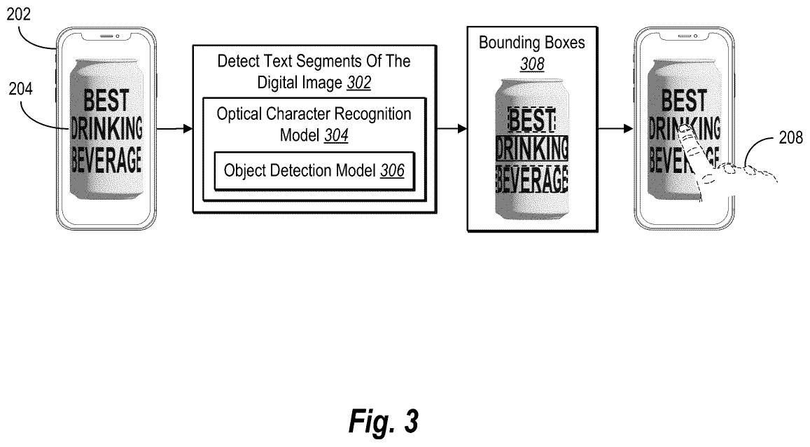

As illustrated in FIG. 2, in some implementations, the depth perspective-aware editing system 106 performs an act 206 of detecting a text segment of a digital image. Specifically, the depth perspective-aware editing system 106 receives the digital image 204 from a client device 202 and detects one or more text segments portrayed in the digital image 204. For example, in one or more embodiments, the depth perspective-aware editing system 106 utilizes an object detection model to detect text segments as discussed in further detail with respect to FIG. 3. In one or more implementations, the text segments of the digital image 204 are portrayed in accordance with a depth perspective of the digital image 204. Additionally, in some embodiments, the text segments of the digital image 204 include non-editable text segments such as text portrayed in a raster image.

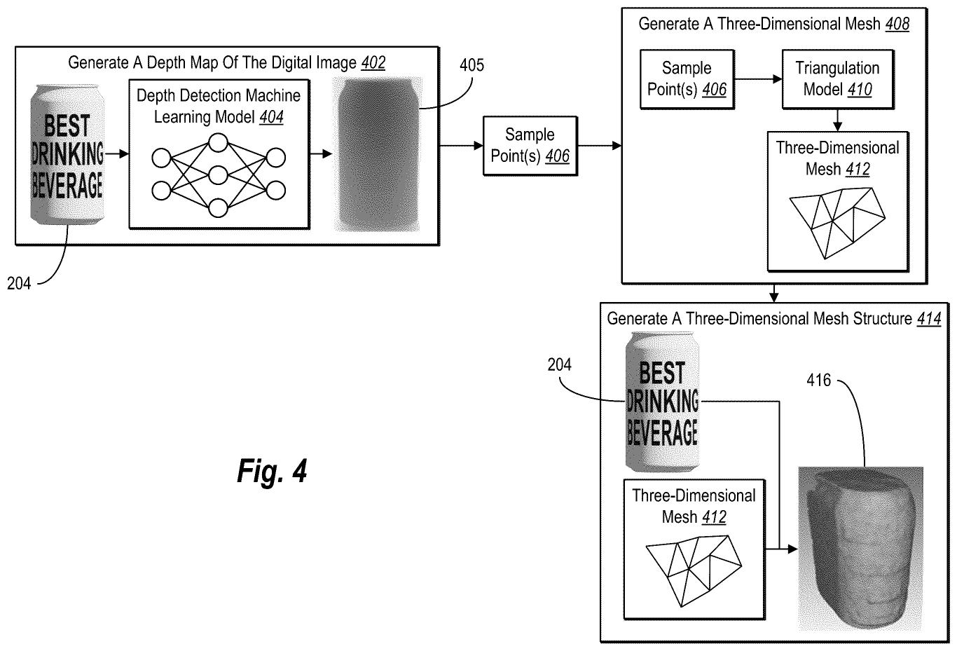

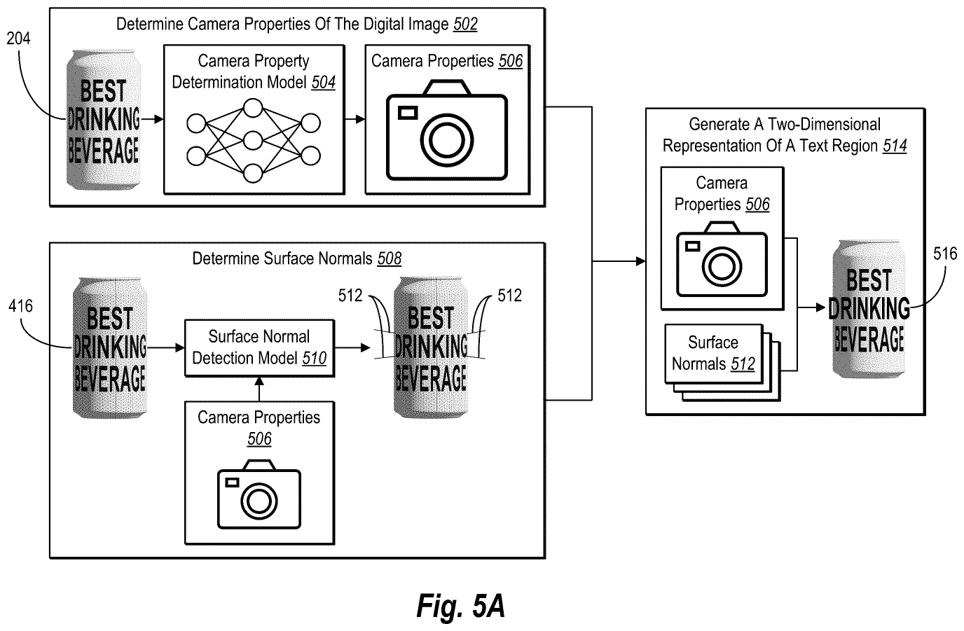

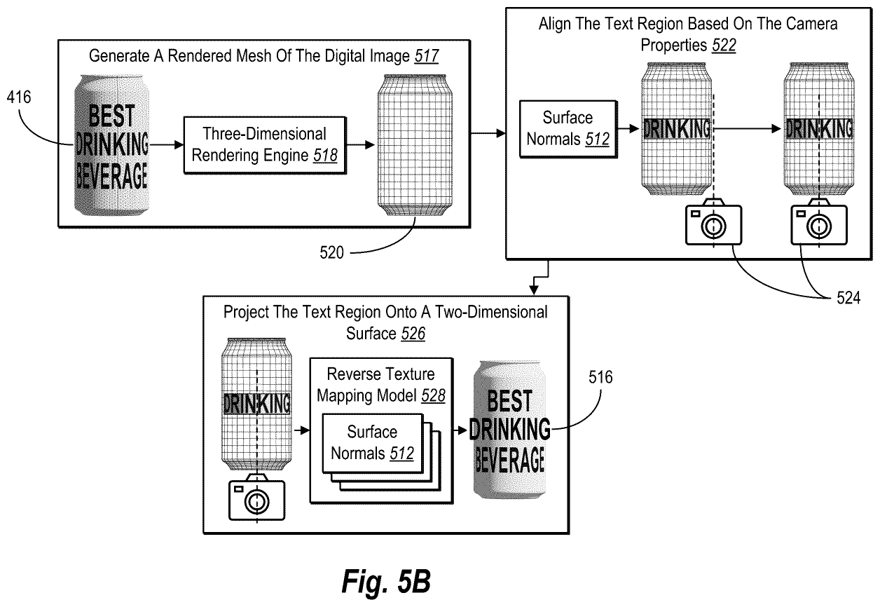

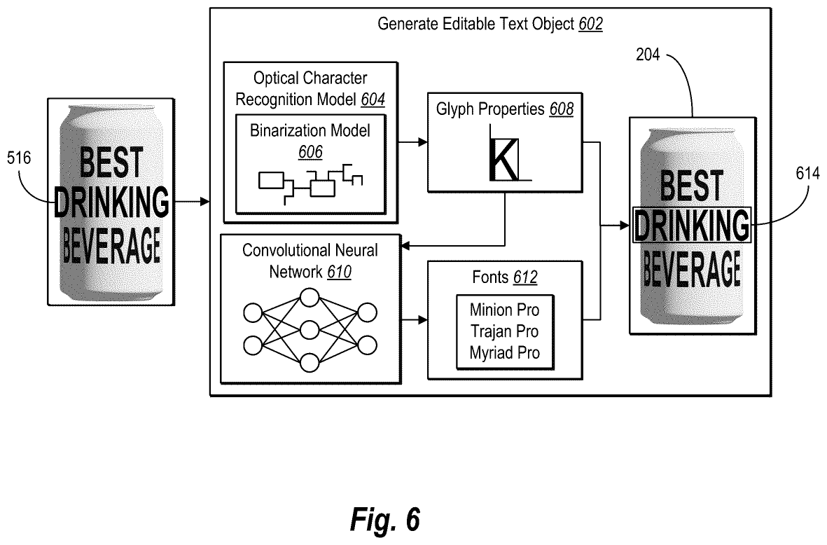

As further illustrated in FIG. 2, in some implementations, the depth perspective-aware editing system 106 performs an act 210 of generating an editable text object 211 from one of the detected text segments. In particular, in some cases, the depth perspective-aware editing system 106 detects a text segment targeted for modification (also referred to herein as a targeted text segment) based on a user input 208 received via a graphical user interface of the client device 202. Further, in one or more embodiments, the depth perspective-aware editing system 106 generates the editable text object 211 from the targeted text segment in accordance with the depth perspective of the digital image 204. For instance, in certain embodiments the depth perspective-aware editing system 106 determines the depth perspective of the digital image 204 by generating a three-dimensional mesh structure of the digital image as described in further detail with respect to FIG. 4. In one or more implementations, the depth perspective-aware editing system 106 utilizes the three-dimensional mesh structure to generate a two-dimensional representation of the text segment as described in further detail with respect to FIGS. 5A and 5B. In some cases, the depth perspective-aware editing system 106 extracts the text of the text segment for inclusion of text within the editable text object 211 as discussed further with respect to FIG. 6.

Though, in some cases, the depth perspective-aware editing system 106 generates the editable text object 211 from the text segment upon determining that the text segment is targeted for modification, the depth perspective-aware editing system generates the editable text object 211 regardless of whether the text segment is targeted in certain embodiments. For instance, in some implementations, the depth perspective-aware editing system 106 detects all text segments within the digital image 204 upon receiving the digital image 204. The depth perspective-aware editing system 106 further generates an editable text object 211 corresponding to each detected text segment. Thus, in some cases, the depth perspective-aware editing system 106 prepares all the text within the digital image 204 for editing in accordance with its depth perspective.

As shown in FIG. 2, the editable text object 211 follows the depth perspective of the digital image 204. In particular, the digital image 204 portrays the editable text object 211 in accordance with depth perspective portrayed therein.

In one or more embodiments, a depth perspective includes a three-dimensional (3D) perspective of a digital image. In particular, in some embodiments, a depth perspective includes a visual depiction or indication of three dimensions within a digital image, such that a visual depth is conveyed by the digital image. For instance, in some implementations, a depth perspective of a digital image causes one or more objects and/or text segments portrayed therein to appear as though they exist in a three-dimensional environment. In other words, in some cases, the depth perspective causes the one or more objects and/or text segments to appear as having depth. Thus, a depth perspective includes, in some implementations, a general 3D appearance of a digital image or a local 3D appearance specific to a portion of the digital image or a particular object or text segment within the digital image.

As mentioned above, in some implementations, the editable text object 211 follows the depth perspective of the digital image 204. Specifically, the editable text object 211 appears to have a visual depth within the digital image. For example, the editable text object 211 visually conforms to the general 3D appearance of the digital image or a local 3D appearance of a portion of the digital image such as a particular object. To illustrate, the editable text object 211 including the word “drinking” has a 3D appearance visually conforming to the 3D appearance of the aluminum can object of the digital image.

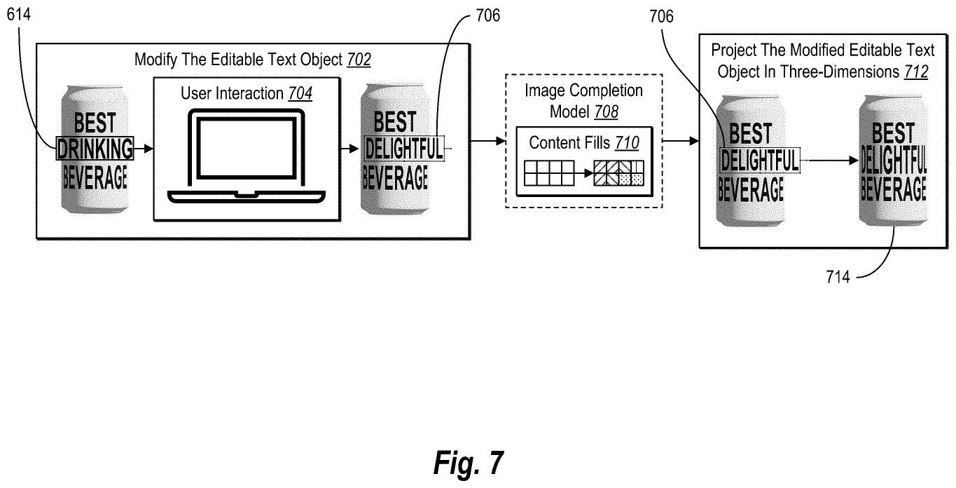

As additionally shown in FIG. 2, in some implementations, the depth perspective-aware editing system 106 performs an act 212 of modifying the editable text object. For example, in certain cases, the depth perspective-aware editing system 106 modifies the editable text object (e.g., modifies the text therein) in response to receiving user input via one or more user interactions through the client device 202. For example, FIG. 2 illustrates the depth perspective-aware editing system 106 modifying the text of the editable text object from “drinking” to “delightful.” As shown in FIG. 2, and as will be described in more detail below, in some cases, the depth perspective-aware editing system presents the editable text object 211 in a two-dimensional representation during modification (e.g., upon detecting a user interaction to modify the editable text object 211, such as a user selection of the editable text object 211). Additional details regarding the modification of the editable text object 211 are provided with respect to FIG. 7.

As further illustrated in FIG. 2, in one or more implementations, the depth perspective-aware editing system 106 performs an act 214 of projecting the modified editable text object 218 into the three-dimensions of the digital image 204. In some embodiments, the depth perspective-aware editing system 106 performs the act 214 of projecting the modified editable text object 218 into the three-dimensions of the digital image 204 as part of modifying the editable text object 211. In other words, in these or other implementations, the act 214 of projecting the modified editable text object 218 in three-dimensions is part of the act 212 of modifying the editable text object 211. In particular, in some cases, the depth perspective-aware editing system 106 projects the modified editable text object 218 onto a three-dimensional mesh structure of the digital image 204 to portray the modified editable text object 218 in accordance with the depth perspective of the digital image 204. Thus, in these or other cases, the depth perspective-aware editing system 106 modifies the editable text object 211 while maintaining the three-dimensional appearance of the text.

As shown, the depth perspective-aware editing system 106 projects the modified editable text object 218 onto the same location (i.e., the text region) from which the text segment was originally detected. In some cases, however, the depth perspective-aware editing system projects the modified editable text object 218 onto a different location. In these or other embodiments, the depth perspective-aware editing system 106 projects the modified editable text object 218 according to the depth perspective at the selected location.

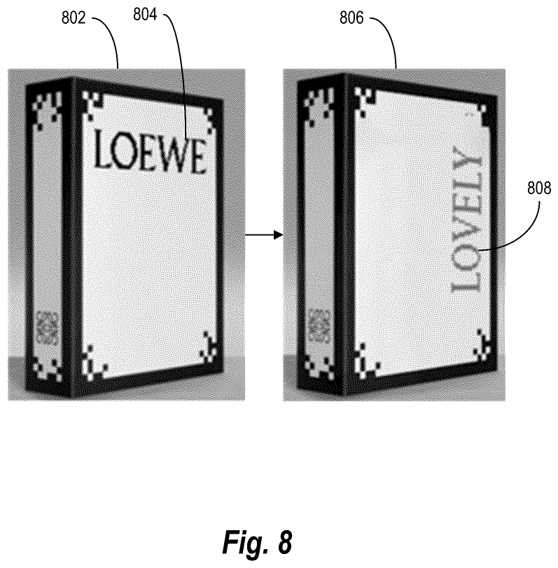

In some embodiments, the depth perspective-aware editing system 106 projects the modified editable text object 218 onto a location within the digital image 204 using non-linear transformation. Moreover, the depth perspective-aware editing system 106 provides the digital image 204 with the modified editable text object 218 projected in three-dimensions to generate a modified digital image 216 for display on the client device 202 as shown in FIG. 2. Further detail regarding projecting the modified editable text object 218 into three-dimensions is provided with respect to FIGS. 7 and 8.

As previously noted, in some implementations, the depth perspective-aware editing system 106 detects one or more text segments portrayed within a digital image. FIG. 3 illustrates the depth perspective-aware editing system 106 detecting one or more text segments portrayed within a digital image in accordance with one or more embodiments.

Indeed, as shown in FIG. 3, the depth perspective-aware editing system 106 receives a digital image 204. In one or more implementations, the depth perspective-aware editing system 106 receives the digital image 204 from a client device 202. As shown, the digital image 204 includes text within one or more text segments.

In some embodiments, a text segment includes text portrayed within a digital image. In particular, in some cases, a text segment includes text within a digital image that is distinct from text within the digital image. For example, in some instances, a text segment includes a distinct portion of text having one or more characters, such as letters, numbers, punctuation marks, accents, symbols, or other markings of a writing system arranged to convey information. To illustrate, in some embodiments, a text segment includes a single letter (or other marking), a word, or group of words. Further, in one or more embodiments, a text segment is associated with certain properties, such as font size, color, location, perspective, orientation, and/or font. Moreover, in some instances, a text segment includes non-editable text. For instance, in certain cases, a text segment includes text from a raster digital image such that the text segment is non-editable without certain pre-processing techniques that facilitates editing of the text.

Indeed, in one or more embodiments, the digital image 204 represents a digital raster image, and the one or more text segments include non-editable text. As shown, the one or more text segments include text that reads “Best Drinking Beverage.” In this example, the text segments are portrayed in accordance with a depth perspective of the digital image 204.

Indeed, as shown in FIG. 3, the digital image 204 portrays an aluminum drinking can. In particular, the aluminum drinking can is portrayed in accordance with a depth perspective of the digital image 204 in that the surface of the can curves away from a camera view direction associated with the digital image 204. In other words, the aluminum drinking can is portrayed as having some depth in that the surface curves away from the direct view of the digital image 204. Further, as shown, the one or more text segments having the text that reads “Best Drinking Beverage” are portrayed on the surface of the aluminum drinking can (e.g., as part of a label) and follow the curvature of the surface. Thus, the digital image 204 portrays the one or more text segments in accordance with the depth perspective.

As depicted in FIG. 3, the depth perspective-aware editing system 106 performs an act 302 of detecting the one or more text segments of the digital image 204. In particular, the depth perspective-aware editing system 106 utilizes an object detection model 306 to detect the text segment(s) of the digital image 204.

In one or more embodiments, an object detection model includes a computer-implemented model that detects targeted content within a digital image. For instance, in some embodiments, an object detection model includes a computer-implemented model that analyzes a digital image and determines whether targeted content is present within the digital image based on the analysis. In some cases, an object detection model further determines the locations or regions of the targeted content within the digital image. In some cases, the content targeted by the object detection model includes text segments. In certain implementations, an object detection model includes a machine learning model, such as a neural network. Indeed, in some cases, an object detection model includes a machine learning model that has been trained to detect text segments within a digital image.

As shown in FIG. 3, in some cases, the depth perspective-aware editing system 106 implements the object detection model 306 as part of an optical character recognition model (an OCR model 304). Indeed, in some embodiments, the depth perspective-aware editing system 106 uses the object detection model 306 to enhance the OCR model 304. For example, in some instances, the depth perspective-aware editing system 106 uses the object detection model 306 to provide improved text segment detection where the characters of text are not within the same visual perspective. Though FIG. 3 illustrates the object detection model 306 as part of the OCR model 304, some embodiments of the depth perspective-aware editing system 106 implement the object detection model 306 as a separate model.

In one or more embodiments, the depth perspective-aware editing system 106 utilizes the object detection model 306 to detect the text segments of the digital image 204 by detecting corresponding text regions within the digital image 204. In particular, in some cases, the depth perspective-aware editing system 106 utilizes the object detection model 306 to distinguish between text regions and non-text regions within the digital image 204.

In one or more embodiments, a text region includes a region within a digital image that portrays a text segment. In some embodiments, a text region includes a region that portrays a text segment and one or more other portions of the digital image. To illustrate, in some cases, a text region includes portions of the digital image immediately surrounding the text segment. Further, in some instances, a text region includes portions of the digital image positioned between the characters of text within the text segment. In contrast, a non-text region includes a region within a digital image that does not portray a text segment. Thus, in some cases, the depth perspective-aware editing system 106 distinguishes between text regions and non-text regions of a digital image by distinguishing between regions having a text segment and regions without a text segment.

To illustrate, the text regions of the digital image 204 include those portions of the digital image 204 portraying a text segment reading “best,” “drinking,” “beverage,” or some combination thereof. Additionally, the non-text regions of the digital image 204 include the other portions of the digital image 204, such as those portions above or below the aluminum drinking can or those portions portraying the top and bottom of the aluminum drinking can, which do not include text.

As mentioned, in some instances, the depth perspective-aware editing system 106 utilizes the object detection model 306 to detect a text region containing a text segment even though the characters of the text segment are not part of the same visual perspective. In some cases, the characters are not part of the same visual perspective due to the depth perspective of the digital image. To illustrate, in the digital image 204 portrayed in FIG. 3, the characters “n” and “k” at the center of the text segment “Drinking” appear different from the characters “d,” “r,” and “g” at the edges of the text segment due to the depth perspective followed by the text segment (e.g., followed by the aluminum can object on which the text segment appears).

In some implementations, the depth perspective-aware editing system 106 utilizes the object detection model 306 to distinguish a text region containing a text segment form another text region containing a different text segment. To illustrate, in one or more embodiments, the depth perspective-aware editing system 106 utilizes the object detection model 306 to determine that the digital image 204 includes three text regions each containing a single text segment as follows, “Best,” “Drinking,” and “Beverage.”

As further illustrated in FIG. 3, the depth perspective-aware editing system 106 uses the object detection model 306 to generate one or more outputs that indicate the detected text regions of the digital image 204. For example, the depth perspective-aware editing system 106 uses the object detection model 306 to output a bounding box around each detected text region. To illustrate, the depth perspective-aware editing system 106 uses the object detection model 306 to generate the bounding boxes 308 around the three text regions with the three text segments of the previous example (i.e., “Best,” “Drinking,” and “Beverage”).

As additionally shown in FIG. 3, in some embodiments, the depth perspective-aware editing system 106 determines that a detected text segment is targeted for modification. In some cases, the depth perspective-aware editing system 106 determines that the text segment is targeted for modification based on user input. To illustrate, FIG. 3 shows the depth perspective-aware editing system 106 receiving user input 208 via the graphical user interface of the client device 202 that indicates the text segment that reads “Drinking” is targeted for modification.

More particularly, in some implementations, the depth perspective-aware editing system 106 determines that the text segment is targeted for modification by determining that control point coordinates of the user input (e.g., the coordinates of a cursor or touch input) intersect with a bounding box of the text region corresponding to the text segment. To illustrate, the depth perspective-aware editing system 106 determines that the text segment reading “Drinking” is targeted for modification by determining that the control point coordinates of the user input 208 received via the client device 202 intersect with a bounding box of the text region corresponding to the text segment reading “Drinking.” Based on identifying the text segment that is targeted for modification, the depth perspective-aware editing system 106 generates an editable text object as described in more detail with respect to FIGS. 4-6.

As mentioned previously, in one or more embodiments, the depth perspective-aware editing system 106 determines the depth perspective of a digital image. In one or more cases, the depth perspective-aware editing system 106 determines the depth perspective of the digital image by generating a three-dimensional mesh structure of the digital image. FIG. 4 illustrates the depth perspective-aware editing system 106 generating a three-dimensional mesh structure of a digital image in accordance with one or more embodiments.

As portrayed in FIG. 4, in some embodiments, the depth perspective-aware editing system 106 generates a three-dimensional (3D) mesh structure for a digital image using one or more machine learning models (MLMs). For instance, as shown, the depth perspective-aware editing system 106 implements a depth detection MLM 404.

In some implementations, an MLM includes a computer-implemented model that is tunable (e.g., trainable) based on inputs to approximate unknown functions. In particular, in some embodiments, a machine-learning model includes a model that utilizes algorithms to learn from, and make predictions on, known data by analyzing the known data to learn to generate outputs that reflect patterns and attributes of the known data. For instance, in some cases, a machine-learning model includes, but is not limited to, a neural network (e.g., a convolutional neural network, recurrent neural network or other deep learning network), a decision tree (e.g., a gradient boosted decision tree), association rule learning, inductive logic programming, support vector learning, Bayesian network, regression-based model, principal component analysis, or a combination thereof.

In one or more embodiments, a depth detection MLM includes an MLM that generates a depth map for a digital image. In particular, in some cases, a depth detection MLM includes a MLM that analyzes a digital image (e.g., a digital raster image) as input and generates a depth map for the digital image based on the analysis. For example, in at least one embodiment, a depth detection MLM includes a MLM that uses monocular depth estimation to generate a depth map. For instance, in some embodiments, a depth detection MLM utilizes monocular depth estimation methods that include transfer learning and/or monocular depth estimation methods that maintain left-right consistency. Various methods for generating a depth map, however, are used in various implementations.

In one or more embodiments, a depth map includes a map of a digital image that indicates a depth portrayed in the digital image. In particular, in some embodiments, a depth map includes a map of a digital image that indicates a depth associated with the contents of the digital image. For instance, in some cases, a depth map includes one or more values that indicate a distance of the contents of the digital image relative to the camera associated with (e.g., that captured) the digital image. To illustrate, in some implementations, a depth map includes a set of values, where each value indicates a distance portrayed by a corresponding pixel of the digital image relative to the camera.

Indeed, as illustrated in FIG. 4, the depth perspective-aware editing system 106 performs an act 402 of generating a depth map 405 of the digital image 204. For example, the depth perspective-aware editing system 106 generates the depth map 405 using the digital image 204 as an input to the depth detection MLM 404. Specifically, the depth perspective-aware editing system 106 generates the depth map 405 to encode the distance of pixels in the digital image 204 from a specific viewpoint or location (e.g., the camera location). Indeed, in some cases, the depth map 405 represents each pixel's depth information. In one or more embodiments, the depth map 405 represents each pixel's depth information via a grayscale image where darker shades indicate pixels with less depth (e.g., closer to the camera) and lighter shades represent those with greater depth (e.g., farther from the camera). In some instances, the depth map 405 represents each pixel's depth information via numerical values (e.g., where a larger value indicates a greater depth).

In one or more embodiments, the depth perspective-aware editing system 106 uses, as the depth detection MLM 404, a machine learning model, such as a neural network, trained to generate depth maps from digital images. For instance, in some cases, the depth perspective-aware editing system 106 trains a neural network using training images and corresponding ground truth depth maps that capture depth data of the training images. In at least one instance, the depth detection MLM 404 includes a convolutional neural having an encoder-decoder architecture where the encoder processes an input image through a plurality of neural network layers to generate one or more feature maps that encode depth data, and the decoder decodes the feature map(s) into a predicted depth map.

As further illustrated in FIG. 4, the depth perspective-aware editing system 106 extracts a set of sample points 406 from the depth map 405. In some embodiments, the depth perspective-aware editing system 106 extracts the sample points 406 based on a depth variation of the depth map 405. To illustrate, in some cases, the depth perspective-aware editing system 106 extracts more sample points where depth varies more, and less sample points where depth varies less. For example, in at least one implementation, the depth perspective-aware editing system 106 divides the depth map into various segments, determines differences in the depths represented in the segments, and samples points from the segments in proportion to the variation in depths represented therein.

As also depicted in FIG. 4, in some embodiments, the depth perspective-aware editing system 106 performs an act 408 of generating a 3D mesh 412 (e.g., a triangle mesh). For example, the depth perspective-aware editing system 106 utilizes the depth map 405 to generate the 3D mesh 412 of the digital image 204. More particularly, the depth perspective-aware editing system 106 generates the 3D mesh 412 from the sample points 406 extracted from the depth map 405. As shown in FIG. 4, the depth perspective-aware editing system 106 uses a triangulation model 410 to generate the 3D mesh 412. The triangulation model 410 creates the 3D mesh 412 using various methods in various implementations. For example, in some cases, the triangulation model 410 creates the 3D mesh 412 using Delaunay triangulation, constrained Delauney triangulation, greedy triangulation, or triangle splitting.

In some embodiments, the depth perspective-aware editing system 106 generates the 3D mesh 412 to include x, y, and z coordinates such that the 3D mesh 412 includes the depth perspective information within the depth map 405. For example, the depth perspective-aware editing system 106 generates the 3D mesh 412 by providing the triangles of the 3D mesh 412 with x, y, and z coordinates. In some cases, the depth perspective-aware editing system 106 uses the x and y coordinates to represent the image coordinates of the digital image 204 and uses the z coordinate to represent the depth.

As further illustrated in FIG. 4, in one or more implementations, the depth perspective-aware editing system 106 performs an act 414 of generating a 3D mesh structure 416. In one or more embodiments, a 3D mesh structure includes an enhanced mesh. In particular, in some embodiments, a 3D mesh structure includes a mesh having additional data added to the mesh or otherwise associated with the mesh. For example, in some cases, a 3D mesh structure includes a mesh and texture added to or otherwise associated with the mesh. To illustrate, in at least one example, a 3D mesh structure includes a combination of a 3D mesh generated from a source digital image and the source digital image (which provides texture).

Indeed, as shown in FIG. 4, the depth perspective-aware editing system 106 generates the 3D mesh structure 416 by combining the 3D mesh 412 with the digital image 204. For instance, the depth perspective-aware editing system 106 combines the 3D mesh 412 with the digital image 204 by mapping the digital image 204 to the 3D mesh 412 of the digital image 204. More specifically, the depth perspective-aware editing system 106 applies the digital image 204 as base texture to the 3D mesh 412. As such, the depth perspective-aware editing system 106 creates a mapping between the two-dimensional image and the three-dimensional mesh.

As noted previously, in some embodiments, the depth perspective-aware editing system 106 generates an editable text object that follows the depth perspective of the digital image. For instance, in some cases, the depth perspective-aware editing system 106 generates the editable text object using a 3d mesh structure generated from the digital image. In some cases, the depth perspective-aware editing system 106 generates a two-dimensional (2D) representation of a text region that includes a text segment (e.g., a text segment targeted for modification) and generates the editable text object using the 3d mesh structure and the 2d representation. FIG. 5A illustrates the depth perspective-aware editing system 106 generating a two-dimensional representation of a text region of a digital image in accordance with one or more embodiments.

In one or more embodiments, to generate a two-dimensional (2D) representation 516 of a text region of the digital image 204, the depth perspective-aware editing system 106 uses one or more camera properties 506 associated with the digital image 204. Indeed, as shown in FIG. 5A, the depth perspective-aware editing system 106 performs an act 502 of determining the camera properties 506 of the digital image 204.

In one or more embodiments, a camera property includes an attribute or characteristic of a digital image with respect to a camera associated with a digital image. In particular, in some embodiments, a camera property includes an attribute or characteristic of a digital image that contributes to the view of the digital image. For instance, in some cases, a camera property includes an attribute or property of a camera that captured the digital image (e.g., at the time the digital image was captured). In instances where the digital image was not captured by a physical camera, a camera property includes an attribute or characteristic that would be attributed to a camera to provide the view of the digital image. Examples of a camera property includes field of view (e.g., wide, narrow, or a degree value), view direction, camera height, focal length, distortion parameters (or distortion coefficients), or principal point offset.

As indicated in FIG. 5A, the depth perspective-aware editing system 106 determines the camera properties 506 associated with the digital image 204 using a camera property determination model 504. In some cases, the camera property determination model 504 includes a neural network.

In one or more embodiments, a neural network includes a model of interconnected artificial neurons (e.g., organized in layers) that communicate and learn to approximate complex functions and generate outputs based on inputs provided to the model. In some instances, a neural network includes one or more machine learning algorithms. Further, in some cases, a neural network includes an algorithm (or set of algorithms) that implements deep learning techniques that utilize a set of algorithms to model high-level abstractions in data. To illustrate, in some embodiments, a neural network includes a convolutional neural network, a recurrent neural network (e.g., a long short-term memory neural network), a generative adversarial network, a graph neural network, a multi-layer perceptron, or a diffusion neural network. In some embodiments, a neural network includes a combination of neural networks or neural network components.

Indeed, in one or more embodiments, the camera property determination model 504 utilizes deep learning to determine camera properties 506 of the digital image 204. In particular, in at least one instance, the depth perspective-aware editing system 106 trains a neural network (e.g., a convolutional neural network (CNN)) to predict extrinsic and intrinsic camera parameters. In some cases, the depth perspective-aware editing system 106 trains the neural network using ground truth annotations that provide camera property labels for training images. In some cases, the depth perspective-aware editing system 106 further trains the camera neural network using multiple losses that reconstruct 3D points of a digital image and/or estimate the camera properties.

As additionally shown in FIG. 5A, in some embodiments, the depth perspective-aware editing system 106 performs an act 508 of determining surface normals 512. In some cases, the depth perspective-aware editing system 106 determines surface normals for a portion of the 3D mesh structure 416 corresponding to the text region containing the targeted text segment. For instance, the depth perspective-aware editing system 106 determines surface normals for the 3D mesh structure 416 corresponding to a text region based on determining that the text segment within the text region is targeted for modification as described above with respect to FIG. 3. To illustrate, the depth perspective-aware editing system 106 determines the surface normals 512 for the 3D mesh structure 416 corresponding to the text region containing the text segment “drinking” as shown in FIG. 5A.

In some implementations, the depth perspective-aware editing system 106 determines the surface normals 512 as vectors perpendicular to a surface (e.g., the 3D mesh structure 416) at a given point. For example, the surface normals 512 serve as indicators of the orientation or direction of the 3D mesh structure 416 at individual points on the 3D mesh structure 416, indicating which way the surface is facing. To illustrate, in some cases, the depth perspective-aware editing system 106 determines the surface normals 512 for individual points of the 3D mesh structure 416 corresponding to the text region containing the text segment “drinking” indicating the 3D orientation or direction of these individual points. FIG. 5A illustrates the depth perspective-aware editing system 106 determining a particular number of surface normals at particular locations around the text segment “drinking,” though various numbers and positions are used in various implementations.

As further shown, in one or more embodiments, the depth perspective-aware editing system 106 utilizes a surface normal detection model 510 to determine the surface normals 512. In some cases, the surface normal detection model 510 performs a hit test based on the relative position of the text region containing the text segment “drinking” and the 3D mesh structure 416 and determines the surface normals 512 using identified hit surfaces from the hit test. Furthermore, in one or more implementations, the depth perspective-aware editing system 106 utilizes the camera properties 506 (e.g., the camera intrinsic parameters) to determine the surface normals 512 via the surface normal detection model 510. For instance, in some embodiments, the surface normal detection model 510 determines the surface normals 512 according to the following algorithm 1:

Algorithm 1 Compute Surface Normals using Gradient Estimation

Require: 3D Mesh or Point Cloud D
1: procedure GETSURFACENORMALS(D)

| | |
|---|---|
| 2: | for each point P in D do |
| 3: | Select a local neighborhood Nₚ around point P |
| 4: | Compute the gradients in the x and y |
| | directions within Nₚ using finite |

differences (or another method)

| | |
|---|---|
| 5: | Gₓ ← Gradient in the x direction |
| 6: | G_{y} ← Gradient in the y direction |
| 7: | Compute the 2D gradient vector G = [Gₓ, G_{y}] |
| 8: | Normalize G to ensure it has a unit length |
| 9: | N ← -G |
| 10: | Use camera intrinsic parameters to map N to a 3D normal vector |
| 11: | Store N as the surface normal for point P |

As shown in algorithm (1), in some implementations, the depth perspective-aware editing system 106 utilizes either the 3D mesh 412 (or the 3D mesh structure 416) or a point cloud.

As also depicted in FIG. 5A, in one or more implementations, the depth perspective-aware editing system 106 performs an act 514 of generating the 2D representation 516 of a text region. In particular, the depth perspective-aware editing system 106 utilizes the camera properties 506 and the surface normals 512 to generate the 2D representation 516 of the text region containing the targeted text segment reading “drinking.” To illustrate, as shown in FIG. 5A, the 2D representation 516 shows the text segment “drinking” with a flat, 2D appearance in contrast to the 3D appearance of the text segment “drinking” in the digital image 204.

As just mentioned, in some embodiments, the depth perspective-aware editing system 106 generates the 2D representation of the text region containing the targeted text segment. To do so, in some implementations, the depth perspective-aware editing system 106 flattens and projects the text region onto a 2D surface. FIG. 5B illustrates the depth perspective-aware editing system 106 flattening and projecting the text region onto a 2D surface in accordance with one or more embodiments.

As illustrated in FIG. 5B, in one or more embodiments, the depth perspective-aware editing system 106 performs an act 517 of generating a rendered mesh 520 of the digital image 204. Specifically, the depth perspective-aware editing system 106 utilizes a 3D rendering engine 518 to generate the rendered mesh 520. For instance, as shown in FIG. 5B, the depth perspective-aware editing system 106 uses the rendering engine 518 to generate the rendered mesh 520 from the 3D mesh structure 416.

In one or more embodiments, a rendered mesh includes an image of a mesh. In particular, in some embodiments, a rendered mesh includes a two-dimensional representation of a mesh. For instance, in some cases, a rendered mesh includes a projection of a 3D mesh (or three-dimensional mesh structure) onto 2D space or otherwise a representation of a 3D mesh via a 2D space. Thus, one or more embodiments, a 3D rendering engine includes a computer-implemented model that generates rendered meshes. For instance, as indicated by FIG. 5B, in some embodiments, a 3D rendering engine generates a rendered mesh from a 3D mesh structure. To illustrate, in some cases, the 3D rendering engine 518 processes geometric data, applies transformations, lighting, shading, and rasterization to create a visual representation of a 3D model, such as the 3D mesh structure 416.

As further illustrated in FIG. 5B, in some embodiments, the depth perspective-aware editing system 106 performs an act 522 of aligning the text region based on the camera properties 506. In particular, the depth perspective-aware editing system 106 utilizes the surface normals 512 to align the text region corresponding to the targeted text segment “drinking” with the camera view direction 524 of the digital image 204. More specifically, the depth perspective-aware editing system 106 adjusts the orientation of the rendered mesh 520 such that the center of the text region of the targeted text segment aligns with the camera view direction 524. In some implementations, the depth perspective-aware editing system 106 sets the camera view direction 524 as directly into the digital image 204. To illustrate, the depth perspective-aware editing system 106 sets the camera view direction 524 as a vector with respective x, y, and z components [0,0,−1] and aligns the center of the text region of the targeted text segment “drinking” with the camera view direction 524.

As additionally shown in FIG. 5B, in one or more embodiments, the depth perspective-aware editing system 106 performs an act 526 of projecting the text region from the digital image 204 onto a 2D surface. Specifically, the depth perspective-aware editing system 106 projects the text region of the targeted text segment aligned with the camera view direction onto the 2D surface. For example, the depth perspective-aware editing system 106 utilizes a reverse texture mapping model 528 to project the text region onto the 2D surface. In some implementations, to project the text region onto the 2D surface, the reverse texture mapping model 528 utilizes the surface normals 512 associated with the rendered mesh 520 within the area of the text region of the targeted text segment. For example, the reverse texture mapping model 528 generates the 2D surface based on the surface normals 512 and projects the text region onto the 2D surface.

In one or more implementations, a reverse texture mapping model includes a computer-implemented model that generates 2D representations of a portion of a digital image having a 3D appearance. In particular, in some embodiments, a reverse texture mapping model utilizes surface details of a 3D object to unwrap or flatten the 3D object into a 2D representation thereof. For example, in some embodiments, a reverse texture mapping model utilizes surface details such as the surface normals to flatten a corresponding text region by projecting the text region to generate the 2D representation aligned with a camera view direction. Indeed, as shown in FIG. 5B, the depth perspective-aware editing system 106 flattens the text region containing the targeted text segment “drinking” in the generated 2D representation 516. In some cases, the reverse texture mapping model 528 utilizes the following algorithm 2:

Algorithm 2 Texture Mapping with
Surface Normals during Flattening

Require: Surface Normals SN, Texture Image T
1: procedure APPLYTEXTUREMAPPING(S, T)

| | |
|---|---|
| 2: | create a 2D texture image 2DTex for the object. |
| 3: | for For each vertex V on the object's surface do |
| 4: | Fetch the surface normal SNᵢ at the vertex. |
| 5: | Associate texture co-ordinates UVᵢ with V |
| 6: | Determine the texture coordinates XYᵢ based on SNᵢ and UVᵢ |
| 7: | pixel ← Sample T at the calculated texture coordinate XYᵢ. |
| 8 | Apply pixel to 2DTex |
| 9: | Project the 3D object onto a 2D plane |
| | for flattening (e.g., UV mapping). |
| 10: | Interpolate texture values between vertices |
| | to create a smooth transition. |

In one or more embodiments, the depth perspective-aware editing system 106 employes a normal map to generate the 2D representation 516 of the targeted text segment. In these or other embodiments, the depth perspective-aware editing system 106 utilizes a MLM to generate a normal map of the digital image. In some cases, the depth perspective-aware editing system 106 utilizes the depth map 405 to generate the normal map of the digital image. Based on the normal map, the depth perspective-aware editing system 106 utilizes the normals of the normal map to project the targeted text segment onto a 2D surface.

As previously mentioned, in one or more implementations, the depth perspective-aware editing system 106 generates an editable text object that follows the depth perspective of the digital image. Indeed, in some embodiments, the depth perspective-aware editing system 106 generates the editable text object from the targeted text segment within the digital image. FIG. 6 illustrates the depth perspective-aware editing system 106 generating an editable text object of a text segment in accordance with one or more embodiments.

As shown in FIG. 6, in some implementations, the depth perspective-aware editing system 106 performs an act 602 of generating an editable text object 614. Specifically, the depth perspective-aware editing system 106 generates the editable text object 614 from the 2D representation 516 of the text region with the targeted text segment. Indeed, based on determining which text segment is targeted for modification (i.e., the text segment “Drinking”), the depth perspective-aware editing system 106 generates the editable text object 614 for the text region of the targeted text segment. In one or more embodiments, the depth perspective-aware editing system 106 generates the editable text object 614 to follow the depth perspective of the digital image 204 as described above with respect to FIG. 2 and as further described below with respect to FIG. 7.

As further illustrated in FIG. 6, in one or more embodiments, the depth perspective-aware editing system 106 generates the editable text object using an OCR model 604. Specifically, the depth perspective-aware editing system 106 extracts or generates editable text from the 2D representation 516 using the OCR model 604. In certain cases, the OCR model 604 includes the OCR model 304 discussed with reference to FIG. 3. Indeed, in some cases, the OCR model 604 detects the text segments from the text of the digital image 204 as described above with respect to the OCR model 304. Furthermore, in some embodiments, the OCR model 604 assists in converting images of text such as text segments into editable text. For example, in some implementations, the OCR model 604 extracts, from a flattened text segment, one or more glyph properties 608 (e.g., low contrast glyph, small glyph, big glyph, etc.).

As shown in FIG. 6, the depth perspective-aware editing system 106 implements a binarization model 606 as (part of) the OCR model 604, though various models are implemented in various implementations. For instance, in some cases, the depth-perspective aware editing system 106 uses gray scale processing, edge detection, or machine learning.

To illustrate, as shown, the depth perspective-aware editing system 106 uses the binarization model 606 to determine the one or more glyph properties 608 (e.g., one or more properties for each character) of the targeted text “drinking” from the corresponding text region projected onto the 2D representation 516.

As also depicted in FIG. 6, in some implementations, the depth perspective-aware editing system 106 uses a convolutional neural network (CNN) 610 to determine fonts 612 of the text segment based on the 2D representation 516. Specifically, the CNN 610 utilizes a deep residual architecture to recommend suitable fonts 612 from an image of text such as the text segments of the digital image 204. To illustrate, in some cases, the CNN 610 uses convolutional layers to extract learned features of the one or more textual characters from the digital image 204 and generate the predicted fonts from the extracted features. In some instances, the depth perspective-aware editing system 106 applies a linear transformation to reduce the dimensionality of the extracted features.

In particular, as illustrated in FIG. 6, the depth perspective-aware editing system 106 uses the one or more glyph properties 608 with the CNN 610 to determine the fonts 612 of the targeted text segment in generating the editable text object 614. Specifically, the depth perspective-aware editing system 106 uses the one or more glyph properties identified by the OCR model 604 (e.g., the binarization model 606) to determine the fonts 612 of the text segment. For instance, in some cases, the depth perspective-aware editing system 106 uses the CNN 610 to recommend corresponding fonts for use in generating the editable text object 614. In some cases, the CNN 610 recommends multiple fonts with corresponding recommendation values (e.g., percentages indicating the confidence that the corresponding fonts match the one or more glyph properties 608). Thus, in some cases, the depth perspective-aware editing system 106 selects the recommended font with the highest recommendation value (or a recommendation value satisfying a threshold) for use in generating the editable text object 614.

Though FIG. 6 illustrates the depth perspective-aware editing system 106 using the CNN 610 to determine the fonts 612, some implementations utilize different neural network architectures. For instance, some cases, use a recurrent neural network or a combination of neural networks.

As additionally shown in FIG. 6, in one or more implementations, the depth perspective-aware editing system 106 generates the editable text object 614 from the one or more glyph properties 608 and/or the fonts 612. Further, the depth perspective-aware editing system 106 generates the editable text object 614 from the text region projected on the 2D representation 516. For example, the depth perspective-aware editing system 106 generates a text object, such as in a vector text format. Moreover, in some embodiments, the depth perspective-aware editing system 106 includes, within the text object, editable text corresponding to the text analyzed by the OCR model 604. In these or other embodiments, the depth perspective-aware editing system 106 further applies the fonts 612 to the text within the text object, thereby generating the editable text object 614. In other words, in some cases, the depth perspective-aware editing system 106 generates the editable text object 614 to include editable text having at least one font selected from the fonts 612 (e.g., the font associated with the highest recommendation value).

As further illustrated in FIG. 6, in some implementations, the depth perspective-aware editing system 106 generates the editable text object 614 within the digital image 204. In particular, in one or more embodiments, the depth perspective-aware editing system 106 generates the editable text object 614 within a digital raster image into which the depth perspective-aware editing system 106 inserts the editable text object 614. In one or more implementations, the depth perspective-aware editing system 106 generates the editable text object 614 to follow the depth perspective of the digital image 204 before modifying the editable text object 614 (e.g., in response to user input) as described and shown above with respect to FIG. 2. Alternatively, in some embodiments, the depth perspective-aware editing system 106 generates the editable text object 614 as a flat, 2D object for modification (e.g., in response to a user input) as shown in FIG. 6. Thus, in some embodiments, the depth perspective-aware editing system 106 projects the editable text object 614 in three dimensions within the image before modification of the editable text object 614 or after modification of the editable text object 614 (as described in further detail with respect to FIG. 7).

As previously noted, in some implementations, the depth perspective-aware editing system 106 modifies a generated editable text object in response to user interactions. Furthermore, in one or more embodiments, the depth perspective-aware editing system 106 projects the modified editable text object in three-dimensions according to the depth perspective of the digital image. FIG. 7 illustrates the depth perspective-aware editing system 106 modifying the editable text object and projecting the modified editable text object in three-dimensions in accordance with one or more embodiments.

Indeed, as previously mentioned, in some cases, the depth perspective-aware editing system 106 generates an editable text object to conform to the underlying 3D structure of the digital image before receiving user input for modifying the text. For instance, in some embodiments, the depth perspective-aware editing system 106 generates the editable text object in accordance with the depth perspective in response to receiving user input for converting non-editable text into editable text but before receiving user input for modifying the text. Thus, in some instances, the depth perspective-aware editing system blends the editable text object with the underlying 3D structure. Upon receiving user input to modify the text, the depth perspective-aware editing system 106 presents a two-dimensional representation of the text object and re-wraps the text onto the underlying 3D structure after making the modifications.

In some implementations, however, the depth perspective-aware editing system 106 generates the editable text object as a flat, two-dimensional object in anticipation of receiving user edits to modify the text. In particular, the depth perspective-aware editing system 106 presents a flat text object, receives user input to modify the text, modifies the text accordingly, and re-wraps the modified text onto the underlying 3D structure of the digital image. Upon receiving subsequent user input to modify the text further, the depth perspective-aware editing system 106 un-wraps the text (e.g., presents the editable text object in a 2D representation) and then re-wraps the text after the further modifications.

In various embodiments (i.e., whether re-wrapping before and after modifications or just after modifications), the depth perspective-aware editing system 106 provides the editable text object within the underlying 3D structure of the digital image. In particular, the depth perspective-aware editing system, projects (e.g., re-wraps) the editable text object onto the underlying structure. In one or more embodiments, the underlying 3D structure of a digital image includes the 3D properties of the digital image. In particular, in some embodiments, the underlying 3D structure includes properties associated with the depth perspective of the digital image. To illustrate, in some cases, the underlying 3D structure of a digital image includes properties, such as angles, curvatures, vanishing points, or depth of a digital image.

As portrayed in FIG. 7, in one or more implementations, the depth perspective-aware editing system 106 performs an action 702 of modifying the editable text object 614. Specifically, in some embodiments, the depth perspective-aware editing system 106 receives a user interaction 704 via a client device portraying the digital image 204. Additionally, in some implementations, the depth perspective-aware editing system 106 modifies the editable text object 614 based on the user interaction 704. For example, the depth perspective-aware editing system 106 modifies the editable text object 614 based on the user interaction 704 to generate a modified editable text object 706 within the digital image 204. As shown, in some cases, the depth perspective-aware editing system 106 generates the modified editable text object 706 by modifying the content (e.g., the text) of the modified editable text object 706 from “drinking” to “delightful.” In one or more embodiments, the depth perspective-aware editing system 106 modifies not only the content but any number of aspects such as font, size, color, etc. (e.g., those characteristics that are modifiable in a vector text format).

Further, in one or more implementations, the depth perspective-aware editing system 106 modifies the editable text object 614 to generate the modified editable text object 706 in accordance with the depth perspective of the digital image 204. For instance, the depth perspective-aware editing system 106 modifies the editable text object 614 in accordance with the depth perspective of the digital image 204 by projecting the modified editable text object 706 in three dimensions as discussed in further detail below.

As also depicted in FIG. 7, in some embodiments, the depth perspective-aware editing system 106 generates one or more content fills 710 for selectively inpainting within the digital image as part of generating a modified digital image 714. In one or more embodiments, a content fill includes a set of pixels generated to replace another set of pixels of a digital image. Indeed, in some embodiments, a content fill includes a set of replacement pixels for replacing another set of pixels. For instance, in some embodiments, a content fill includes a set of pixels generated to fill a hole (e.g., a content void) that remains after (or if) a set of pixels (e.g., a set of pixels portraying text) has been removed from or moved within a digital image. In some cases, a content fill corresponds to a background of a digital image (or a background against which text is portrayed). In some cases, a content fill includes an inpainting segment, such as an inpainting segment generated from other pixels (e.g., other background pixels) within the digital image. In some cases, a content fill includes other content (e.g., arbitrarily selected content or content selected by a user) to fill in a hole or replace another set of pixels.

Indeed, in some implementations, extracting text from the digital image 204 when generating the editable text object 614 leaves the pixels in the area previously occupied by the text segment and/or the text region containing the targeted text segment empty. In some examples, the modified editable text object 706 does not cover the empty pixels, even where the modified editable text object 706 is similarly positioned within the digital image 204. Thus, in one or more embodiments, the depth perspective-aware editing system 106 generates the one or more content fills 710 to fill the empty pixels.

In one or more implementations, the depth perspective-aware editing system 106 generates the one or more content fills 710 using a generative machine learning model such as a diffusion model. Specifically, in some embodiments, the depth perspective-aware editing system 106 generates the one or more content fills 710 using an image completion model 708. In one or more embodiments, an image completion model includes a computer-implemented model that generates content for a digital image. In particular, in some embodiments, an image completion model includes a computer-implemented model that generates one or more content fills for a digital image. In some cases, an image completion model includes a machine learning model, such as a neural network. Indeed, as just suggested, in some instances, an image completion model includes a generative neural network.

In some implementations, the image completion model 708 predicts and reconstructs missing information from the digital image, such as empty pixels, based on the context of the digital image 204. Further, in some embodiments, the depth perspective-aware editing system, 106 implements, as the image completion model 708, a neural network. For instance, in some cases, the depth perspective-aware editing system 106 identifies a set of pixels within a digital image and uses an inpainting neural network to generate one or more content fills for use in replacing another set of pixels within the same image based on the identified pixels. In some cases, the depth perspective-aware editing system 106 identifies pixels for use in replacing other pixels based on one or more contexts of the pixels within the digital image (e.g., structure, depth, boundaries, and/or semantic labels associated with the various pixels).

In some implementations, the depth perspective-aware editing system 106 utilizes the one or more content fills 710 with the modified editable text object 706 to generate the modified digital image 714. In these or other embodiments, the depth perspective-aware editing system 106 generates the modified digital image 714 by seamlessly combining the content fills and the modified editable text object 706. For example, in one or more embodiments, the depth perspective-aware editing system 106 exposes the one or more content fills 710 upon modifying the editable text object 614 to generate the modified editable text object 706 rather than exposing empty pixels. In other words, the depth perspective-aware editing system generates the modified digital image 714 to expose pixels of the one or more content fills 710 rather than exposing empty pixels that would otherwise remain upon modification of the editable text object 614.

As further illustrated in FIG. 7, in one or more implementations, the depth perspective-aware editing system 106 performs an act 712 of projecting the modified editable text object into three dimensions. Specifically, the depth perspective-aware editing system 106 projects the modified editable text object 706 onto the underlying 3D structure of the digital image 204 to follow the depth perspective of the digital image 204. For instance, in some cases, the depth perspective-aware editing system 106 projects the modified editable text object 706 onto the 3D mesh structure generated for the digital image 204. By projecting the modified editable text object 706 onto the underlying 3D structure (e.g., the 3D mesh structure), the depth perspective-aware editing system 106 generates a modified digital image 714 with the modified editable text object applied to the modified digital image 714 according to the depth perspective of the modified digital image 714. To illustrate, the depth perspective-aware editing system 106 projects the modified editable text object 706 reading “delightful” onto the modified digital image 714 according to the depth perspective of the modified digital image 714 (which, in some embodiments, is the same depth perspective as that of the digital image). In one or more embodiments, the depth perspective-aware editing system 106 uses one or more transformations, such as piece-wise non-linear transformations, in projecting the modified editable text object onto the underlying 3D structure as will be discussed more below.

As mentioned above, in some implementations, the depth perspective-aware editing system 106 projects the modified editable text object within the digital image. In one or more embodiments, the depth perspective-aware editing system 106 projects and displays the modified editable text object in various positions within the digital image according to the appropriate depth perspective of the position. Indeed, in some cases, upon moving an editable text object within the digital image, the depth perspective-aware editing system 106 projects the editable text object in accordance with the local depth perspective of the new location. In accordance with one or more embodiments, FIG. 8 illustrates the depth perspective-aware editing system 106 displaying the modified editable text object in a second location of the digital image (a location other than the initial location of the corresponding text) according to the depth perspective of the second location.

As depicted in FIG. 8, in one or more implementations, the depth perspective-aware editing system 106 repositions a modified editable text object 808 within the digital image. For example, the digital image 802 includes an editable text object 804 with content “Loewe” that the depth perspective-aware editing system 106 generates as described above in FIGS. 2-7. In addition to repositioning the modified editable text object 808, in some embodiments, the depth perspective-aware editing system 106 also modifies the content of the editable text object 804 from “Loewe” to generate the modified editable text object 808 reading “Lovely” using embodiments described above with respect transformation operations FIG. 7.

To illustrate, in addition to modifying the content of the editable text object 804, the depth perspective-aware editing system 106 generates the modified digital image 806 by repositioning the modified editable text object 808. More specifically, the depth perspective-aware editing system 106 repositions the editable text object 804 from a first region near the top of the digital image 802 to a differing second region near the right edge of the modified digital image 806. In some implementations, the depth perspective-aware editing system 106 repositions the modified editable text object 808 in response to user interactions received from a client device. Furthermore, in one or more embodiments, the depth perspective-aware editing system 106 repositions the modified editable text object 808 in accordance with the depth perspective of the second region.

As just mentioned, the depth perspective-aware editing system 106 repositions the modified editable text object 808 in accordance with the depth perspective of the second region. Specifically, the depth perspective-aware editing system 106 projects the modified editable text object 808 onto the underlying 3D structure of the digital image to generate the modified digital image 806. For example, the depth perspective-aware editing system 106 projects the modified editable text object 808 onto the underlying 3D structure of the digital image by aligning the modified editable text object 808 with the underlying 3D mesh structure.

In one or more implementations, the depth perspective-aware editing system 106 aligns the modified editable text object 808 with the underlying 3D mesh structure using non-linear transformation. In particular, the depth perspective-aware editing system 106 aligns the modified editable text object 808 with the underlying 3D mesh structure via non-linear transformation operations. For instance, in some cases, the depth perspective-aware editing system 106 utilizes one or more piecewise non-linear transformations. To illustrate, in some cases, the depth perspective-aware editing system 106 applies the piecewise non-linear transformation on an input vector geometry (e.g., the modified editable text object 808). Accordingly, in these or other embodiments, the depth perspective-aware editing system 106 displays (e.g., via a client device) the modified editable text object 808 in accordance with the depth perspective of the digital image regardless of the position within the digital image of the second region.

As noted above, FIG. 8 illustrates that, in some implementations, the depth perspective-aware editing system 106 repositions the editable text object 804 in addition to modifying the content of the editable text object 804 from “Loewe” to “Lovely.” In these or other embodiments, the depth perspective-aware editing system 106 repositions the modified editable text object 808 before, after, or without modifying the content of the editable text object 804.

By generating an editable text object that follows the depth perspective of a digital image as described above, the depth perspective-aware editing system 106 operates with improved flexibility, efficiency, and accuracy relative to conventional systems. For example, by determining the 3D mesh structure of a digital image, generating a rendered mesh of the digital image, generating a 2D representation of the targeted text segment, and projecting the modified text back onto 3D space, the depth perspective-aware editing system 106 flexibly provides editable text objects that conform to the underlying 3D structure of a digital image. Moreover, the depth perspective-aware editing system 106 performs these actions behind-the-scenes in response to minimal user interaction via a client device. In other words, the depth perspective-aware editing system 106 behaves intelligently to reduce the number of user interactions typically required by conventional systems. Using conforming editable text objects, the depth perspective-aware editing system 106 generates editing results that more accurately portray edited text within a 3D environment.

Turning to FIG. 9, additional detail will now be provided regarding various components and capabilities of the depth perspective-aware editing system 106. In particular, FIG. 9 illustrates an example schematic diagram of a computing device 900 (e.g., the server device(s) 102 and/or the client device 110) implementing the depth perspective-aware editing system 106 in accordance with one or more embodiments. As illustrated in FIG. 9, the depth perspective-aware editing system 106 includes a text segment manager 902, a depth perspective manager 904, a two-dimensional (2D) representation manager 906, an object modification manager 908, an image completion model 910, a text projector 912, and data storage 914.

As just mentioned, the depth perspective-aware editing system 106 includes the text segment manager 902. In one or more embodiments, the text segment manager 902 accesses a digital image and detects text segments with the digital image. For example, the text segment manager 902 detects text segments portrayed in accordance with the depth perspective of the digital image. In particular, the text segment manager 902 detects text regions with the digital images that include text segments. Additionally, the text segment manager 902 generates outputs such as bounding boxes about the detected text regions containing the text segments.

In one or more embodiments, the depth perspective manager 904 determines a depth perspective of a digital image. In particular, in some embodiments, the depth perspective manager 904 generates a 3D mesh structure of the digital images. For example, the depth perspective manager 904 generates the 3D mesh structure by generating a depth map of the digital image using a depth-detection MLM. Additionally, in one or more embodiments, the depth perspective manager 904 determines sample points from the depth map to generate a 3D mesh from the sample points using a triangulation model. Further, in one or more implementations, the depth perspective-aware editing system 106 generates a 3D mesh structure by applying the digital image as base texture to the 3D mesh.

In one or more embodiments, the 2D representation manager 906 projects a text region of the digital image onto a 2D surface to generate a 2D representation of the text region. Specifically, the 2D representation manager receives a text region from the text segment manager 902 and the 3D mesh structure from the depth perspective manager 904. Moreover, in some embodiments, the 2D representation manager 906 determines camera properties for the digital image and surface normals of the 3D mesh structure to generate the 2D representation of the text region. For instance, in some cases, the 2D representation manager 906 generates a rendered mesh of the digital image, aligns the text region with one or more camera properties by adjusting the orientation of the rendered mesh such that the center of the text region aligns with the one or more camera properties. Furthermore, the 2D representation manager 906 flattens the text region comprising a text segment by projecting the text region onto the 2D surface using the surface normals with a reverse texture mapping model.

In certain embodiments, the object modification manager 908 receives the 2D representation of the text region to generate an editable text object. For example, the object modification manager 908 utilizes an OCR model to extract editable text from the text region containing a text segment. Specifically, the object modification manager 908 generates the editable text object that follows the depth perspective of the digital image and inserts the editable text therein. Additionally, in some implementations, the object modification manager 908 modifies the editable text object in response to receiving user interaction via client device portraying the digital image.

In one or more embodiments, the image completion model 910 generates content fills in addition to modifying the editable text object. Specifically, generates content fills using an image completion model. For example, the image completion model 910 generates the content fills to fill empty pixels resulting from modifying the editable text object. In one or more implementations, the depth perspective-aware editing system 106 exposes the content fills as a result of modifying the editable text object.

The text projector 912 projects the modified editable text object in three dimensions. For example, the text projector 912 receives the modified editable text object from the object modification manager 908. Further, the text projector 912 projects the modified editable text object onto the 3D mesh structure of the digital image to portray the modified editable text object in accordance with the depth perspective of the digital image.

The data storage 914 stores digital documents including digital images such as raster images and/or vector graphics documents, editable text objects, etc. For example, the data storage 914 stores digital documents accessed from user files including server and/or client device documents.

In one or more embodiments, each of the components 902-914 of the depth perspective-aware editing system 106 includes software, hardware, or both. For example, in some embodiments, the components 902-914 include one or more instructions stored on a computer-readable storage medium and executable by processors of one or more computing devices, such as a client device or server device. When executed by the one or more processors, the computer-executable instructions of the depth perspective-aware editing system 106 cause the computing device(s) to perform the methods described herein. Alternatively, in some cases, the components 902-914 include hardware, such as a special-purpose processing device to perform a certain function or group of functions. Alternatively, in some instances, the components 902-914 of the depth perspective-aware editing system 106 include a combination of computer-executable instructions and hardware.

Furthermore, in one or more embodiments, the components 902-914 of the depth perspective-aware editing system 106 are implemented as one or more operating systems, as one or more stand-alone applications, as one or more modules of an application, as one or more plug-ins, as one or more library functions or functions that may be called by other applications, and/or as a cloud-computing model. Thus, in some cases, the components 902-914 of the depth perspective-aware editing system 106 are implemented as a stand-alone application, such as a desktop or mobile application. Furthermore, in some embodiments, the components 902-914 of the depth perspective-aware editing system 106 are implemented as one or more web-based applications hosted on a remote server. In some cases, the components 902-914 of the depth perspective-aware editing system 106 are implemented in a suite of mobile device applications or “apps.” For example, in one or more embodiments, the depth perspective-aware editing system 106 comprises or operates in connection with digital software applications such as ADOBE® PHOTOSHOP®, ADOBE® ILLUSTRATOR®, and/or ADOBE® INDESIGN®. The foregoing are either registered trademarks or trademarks of Adobe Inc. in the United States and/or other countries.

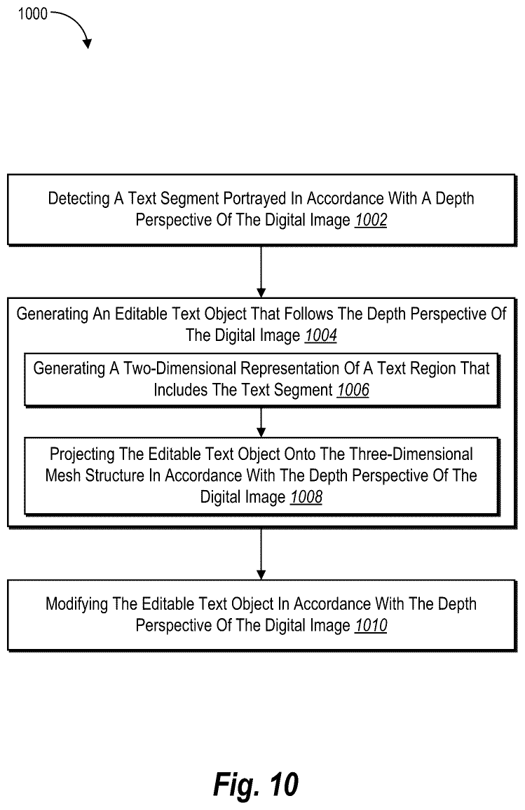

FIGS. 1-9, the corresponding text, and the examples provide a number of different systems, methods, and non-transitory computer readable media for generating a modified editable text object that follows a depth perspective of a digital image from a text segment portrayed according to the depth perspective. In addition to the foregoing, some embodiments are described in terms of flowcharts comprising acts for accomplishing a particular result. For example, FIG. 10 illustrates a flowchart of an example sequence of acts in accordance with one or more embodiments.

While FIG. 10 illustrates acts according to some embodiments, alternative embodiments may omit, add to, reorder, and/or modify any of the acts shown in FIG. 10. In one or more embodiments, the acts of FIG. 10 are performed as part of a computer-implemented method. Alternatively, in some cases, a non-transitory computer-readable medium stores instructions, that when executed by a processing device, cause the processing device to perform operations comprising the acts of FIG. 10. In still further embodiments, a system performs the acts of FIG. 10. For example, in some cases, a system includes one or more memory devices. The system further includes one or more processors configured to cause the system to perform the acts of FIG. 10.

FIG. 10 illustrates an example series of acts 1000 for generating a modified editable text object that follows a depth perspective of a digital image from a text segment portrayed according to the depth perspective. In some embodiments, the series of acts 1000 includes an act 1002 of detecting a text segment portrayed in accordance with a depth perspective of the digital image; an act 1004 of generating an editable text object that follows the depth perspective of the digital image; an act 1006 of generating a two-dimensional representation of a text region that includes the text segment; an act 1008 of projecting the editable text object onto the three-dimensional mesh structure in accordance with the depth perspective of the digital image; and an act 1010 of modifying the editable text object in accordance with the depth perspective of the digital image.

In some embodiments, the series of acts 1000 includes detecting, from a digital image displayed by a client device, a text segment portrayed in accordance with a depth perspective of the digital image. In some embodiments, the series of acts 1000 also includes an act of generating, within the digital image and from the text segment, an editable text object that follows the depth perspective of the digital image. In some implementations, the series of acts 1000 further includes an act of modifying, in response to receiving one or more user interactions via the client device, the editable text object in accordance with the depth perspective of the digital image.

In some implementations, detecting the text segment portrayed in accordance with the depth perspective of the digital image includes detecting, utilizing an object detection model, a text region within a digital raster image, the text region including the text segment portrayed in accordance with the depth perspective of the digital image and a bounding box around the text region.

In one or more embodiments, the series of acts 1000 includes generating a three-dimensional mesh of the digital image based on a depth map of the digital image. Additionally, in one or more embodiments, the series of acts 1000 includes an act of generating a three-dimensional mesh structure by combining the three-dimensional mesh with the digital image, wherein generating the editable text object that follows the depth perspective of the digital image includes generating the editable text object from the three-dimensional mesh structure.

In one or more implementations, generating the editable text object that follows the depth perspective of the digital image includes generating, from the digital image, a two-dimensional representation of a text region that includes the text segment. Moreover, in one or more implementations, the series of acts 1000 also includes an act of generating the editable text object from the two-dimensional representation of the text region. In some embodiments, the series of acts 1000 further includes an act of projecting the editable text object onto an underlying three-dimensional structure of the digital image.

In some embodiments, generating the two-dimensional representation of the text region includes generating, utilizing a three-dimensional rendering engine, a rendered mesh of the digital image. Additionally, in some implementations, the series of acts 1000 includes an act of aligning a center of the text region with a camera view direction of the digital image. In one or more embodiments, the series of acts 1000 also includes an act of projecting the text region aligned with the camera view direction onto a two-dimensional surface.

In some implementations, projecting the editable text object onto the underlying three-dimensional structure of the digital image includes aligning, utilizing non-linear transformation, the editable text object with the underlying three-dimensional structure.

In one or more embodiments, the series of acts 1000 includes generating one or more content fills for the editable text object using an image completion model. In one or more implementations, the series of acts 1000 further includes an act of exposing the one or more content fills upon modifying the editable text object.

In one or more implementations, the series of acts 1000 includes generating a three-dimensional mesh structure from a digital raster image that portrays a text segment in accordance with a depth perspective. Additionally, in some embodiments, the series of acts 1000 includes an act of flattening a text region including the text segment by projecting the text region onto a two-dimensional surface using the three-dimensional mesh structure. In some implementations, he series of acts 1000 also includes an act of generating, using an optical character recognition model and from the projected text region, an editable text object for the text segment. In one or more embodiments, the series of acts 1000 further includes an act of modifying the editable text object in response to receiving one or more user interactions via a client device portraying the digital raster image. Additionally, in one or more implementations, the series of acts 1000 includes an act of projecting the modified editable text object onto the three-dimensional mesh structure to portray the modified editable text object in accordance with the depth perspective of the digital raster image.

In some embodiments, the series of acts 1000 includes detecting the text segment portrayed in accordance with the depth perspective of the digital raster image by using an object detection model to generate one or more outputs that distinguish between one or more text regions of the digital raster image from one or more non-text regions of the digital raster image, wherein at least one text region includes the text segment.

In some implementations, to the series of acts 1000 includes generating the three-dimensional mesh structure from the digital raster image based by generating, utilizing a depth detection machine learning model, a depth map of the digital raster image. In some embodiments, the series of acts 1000 also includes an act of generating a three-dimensional mesh of the digital raster image from the depth map of the digital raster image. In some implementations, the series of acts 1000 further includes an act of generating the three-dimensional mesh structure by combining the digital raster image with the three-dimensional mesh of the digital raster image.

In one or more embodiments, generating the three-dimensional mesh of the digital raster image from the depth map includes extracting a set of sample points from the depth map of the digital raster image based on a depth variation of the depth map. Additionally, in one or more embodiments, the series of acts 1000 includes an act of generating a triangle mesh from the set of sample points.

In one or more implementations, projecting the text region onto the two-dimensional surface using the three-dimensional mesh structure includes determining one or more surface normals for a portion of the three-dimensional mesh structure corresponding to the text region. In one or more implementations, the series of acts 1000 also includes an act of adjusting an orientation of the three-dimensional mesh structure such that a center of the text region aligns with a camera view direction of the digital raster image. In some embodiments, the series of acts 1000 further includes an act of projecting, using a reverse texture mapping model, the text region aligned with the camera view direction onto the two-dimensional surface.

In some embodiments, series of acts 1000 includes determining, using a neural network, at least one camera property associated with the digital raster image, wherein determining the one or more surface normals for the portion of the three-dimensional mesh structure includes determining the one or more surface normals using the at least one camera property.

In some implementations, series of acts 1000 includes generating a modified digital raster image by repositioning the modified editable text object at a second region of the digital raster image that differs from the text region including the text segment in accordance with the depth perspective at the second region.

In one or more embodiments, the series of acts 1000 includes detecting, from a digital image displayed by a client device, a text segment portrayed in accordance with a depth perspective of the digital image. Additionally, in some implementations, the series of acts 1000 includes an act of generating, within the digital image and from the text segment, an editable text object that follows the depth perspective of the digital image. In one or more embodiments, the series of acts 1000 also includes an act of generating, using an image completion model, one or more content fills for the editable text object. In one or more implementations, the series of acts 1000 further includes an act of modifying, in response to receiving one or more user interactions via the client device, the editable text object in accordance with the depth perspective of the digital image, wherein modifying the editable text object exposes the one or more content fills.

In one or more implementations, detecting the text segment portrayed in accordance with the depth perspective of the digital image includes detecting the text segment portrayed on an object of the digital image, the object following the depth perspective of the digital image.

In some embodiments, series of acts 1000 includes generating the editable text object within the digital image includes generating the editable text object within a raster digital image.

In some implementations, series of acts 1000 includes determining that the text segment is targeted for modification by determining that control point coordinates of input received via the client device intersect with a bounding box of a text region corresponding to the text segment, wherein generating the editable text object from the text segment includes generating the editable text object based on determining that the text segment is targeted for modification.

In one or more embodiments, series of acts 1000 includes modifying the editable text object includes modifying the editable text object via one or more transformation operations in accordance with the depth perspective of the digital image.

In one or more implementations, series of acts 1000 includes determining a three-dimensional mesh structure of the digital image by generating, utilizing a machine learning model, a depth map of the digital image. Additionally, in some embodiments, the series of acts 1000 includes an act of generating a three-dimensional mesh of the digital image based on the depth map of the digital image. In some implementations, the series of acts 1000 also includes an act of mapping the digital image to the three-dimensional mesh, wherein generating the editable text object from the text segment includes generating the editable text object from the text segment using the three-dimensional mesh structure.

Embodiments of the present disclosure may comprise or utilize a special purpose or general-purpose computer including computer hardware, such as, for example, one or more processors and system memory, as discussed in greater detail below. Implementations within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

In one or more embodiments, computer-readable media includes any available media that is accessible by a general purpose or special purpose computer system. Computer-readable media that store computer-executable instructions are non-transitory computer-readable storage media (devices). Computer-readable media that carry computer-executable instructions are transmission media. Thus, by way of example, and not limitation, implementations of the disclosure comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium usable to store desired program code means in the form of computer-executable instructions or data structures and accessible by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. In some embodiments, transmissions media includes a network and/or data links that are usable to carry desired program code means in the form of computer-executable instructions or data structures and which are accessible by a general purpose or special purpose computer. Combinations of the above should also be included within the scope of computer-readable media.

Further, in some cases, upon reaching various computer system components, program code means in the form of computer-executable instructions or data structures are transferred automatically from transmission media to non-transitory computer-readable storage media (devices) (or vice versa). For example, in some instances, computer-executable instructions or data structures received over a network or data link are buffered in RAM within a network interface module (e.g., a “NIC”), and then eventually transferred to computer system RAM and/or to less volatile computer storage media (devices) at a computer system. Thus, it should be understood that, in some embodiments, non-transitory computer-readable storage media (devices) is included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some implementations, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multiprocessor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Various implementations of the present disclosure are implemented in cloud computing environments. In this description, “cloud computing” is defined as a model for enabling on-demand network access to a shared pool of configurable computing resources. For example, in some embodiments, cloud computing is employed in the marketplace to offer ubiquitous and convenient on-demand access to the shared pool of configurable computing resources. In some instances, the shared pool of configurable computing resources is rapidly provisioned via virtualization and released with low management effort or service provider interaction, and then scaled accordingly.

In one or more embodiments, a cloud-computing model is composed of various characteristics such as, for example, on-demand self-service, broad network access, resource pooling, rapid elasticity, measured service, and so forth. In some cases, a cloud-computing model exposes various service models, such as, for example, Software as a Service (“SaaS”), Platform as a Service (“PaaS”), and Infrastructure as a Service (“IaaS”). In some instances, a cloud-computing model is deployed using different deployment models such as private cloud, community cloud, public cloud, hybrid cloud, and so forth. In this description and in the claims, a “cloud-computing environment” is an environment in which cloud computing is employed.

FIG. 11 illustrates a block diagram of exemplary computing device 1100 (e.g., the server device(s) 102 and/or the client device 110) that may be configured to perform one or more of the processes described above. One will appreciate that server device(s) 102 and/or the client device 110 may comprise one or more computing devices such as computing device 1100. As shown by FIG. 11, in one or more embodiments, a computing device 1100 comprises processor 1102, memory 1104, storage device 1106, I/O interface 1108, and communication interface 1110, which may be communicatively coupled by way of communication infrastructure 1112. While an exemplary computing device 1100 is shown in FIG. 11, the components illustrated in FIG. 11 are not intended to be limiting. Additional or alternative components may be used in other implementations. Furthermore, in certain implementations, computing device 1100 includes fewer components than those shown in FIG. 11. Components of computing device 1100 shown in FIG. 11 will now be described in additional detail.

In particular implementations, processor 1102 includes hardware for executing instructions, such as those making up a computer program. As an example and not by way of limitation, to execute instructions, processor 1102 may retrieve (or fetch) the instructions from an internal register, an internal cache, memory 1104, or storage device 1106 and decode and execute them. In particular implementations, processor 1102 may include one or more internal caches for data, instructions, or addresses. As an example and not by way of limitation, processor 1102 may include one or more instruction caches, one or more data caches, and one or more translation lookaside buffers (TLBs). Instructions in the instruction caches may be copies of instructions in memory 1104 or storage device 1106.

Memory 1104 may be used for storing data, metadata, and programs for execution by the processor(s). Memory 1104 may include one or more of volatile and non-volatile memories, such as Random Access Memory (“RAM”), Read Only Memory (“ROM”), a solid state disk (“SSD”), Flash, Phase Change Memory (“PCM”), or other types of data storage. Memory 1104 may be internal or distributed memory.

Storage device 1106 includes storage for storing data or instructions. As an example and not by way of limitation, in some embodiments, storage device 1106 comprises a non-transitory storage medium described above. Storage device 1106 may include a hard disk drive (HDD), a floppy disk drive, flash memory, an optical disc, a magneto-optical disc, magnetic tape, or a Universal Serial Bus (USB) drive or a combination of two or more of these. Storage device 1106 may include removable or non-removable (or fixed) media, where appropriate. Storage device 1106 may be internal or external to computing device 1100. In particular implementations, storage device 1106 is non-volatile, solid-state memory. In other implementations, Storage device 1106 includes read-only memory (ROM). Where appropriate, this ROM may be mask programmed ROM, programmable ROM (PROM), erasable PROM (EPROM), electrically erasable PROM (EEPROM), electrically alterable ROM (EAROM), or flash memory or a combination of two or more of these.

I/O interface 1108 allows a user to provide input to, receive output from, and otherwise transfer data to and receive data from computing device 1100. I/O interface 1108 may include a mouse, a keypad or a keyboard, a touch screen, a camera, an optical scanner, network interface, modem, other known I/O devices or a combination of such I/O interfaces. I/O interface 1108 may include one or more devices for presenting output to a user, including, but not limited to, a graphics engine, a display (e.g., a display screen), one or more output drivers (e.g., display drivers), one or more audio speakers, and one or more audio drivers. In certain implementations, I/O interface 1108 is configured to provide graphical data to a display for presentation to a user. The graphical data may be representative of one or more graphical user interfaces and/or any other graphical content as may serve a particular implementation.

In some implementations, communication interface 1110 includes hardware, software, or both. In some instances, communication interface 1110 provides one or more interfaces for communication (such as, for example, packet-based communication) between computing device 1100 and one or more other computing devices or networks. As an example and not by way of limitation, communication interface 1110 may include a network interface controller (NIC) or network adapter for communicating with an Ethernet or other wire-based network or a wireless NIC (WNIC) or wireless adapter for communicating with a wireless network, such as a WI-FI.

Additionally or alternatively, communication interface 1110 may facilitate communications with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, communication interface 1110 may facilitate communications with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination thereof.

Additionally, communication interface 1110 may facilitate communications various communication protocols. Examples of communication protocols that may be used include, but are not limited to, data transmission media, communications devices, Transmission Control Protocol (“TCP”), Internet Protocol (“IP”), File Transfer Protocol (“FTP”), Telnet, Hypertext Transfer Protocol (“HTTP”), Hypertext Transfer Protocol Secure (“HTTPS”), Session Initiation Protocol (“SIP”), Simple Object Access Protocol (“SOAP”), Extensible Mark-up Language (“XML”) and variations thereof, Simple Mail Transfer Protocol (“SMTP”), Real-Time Transport Protocol (“RTP”), User Datagram Protocol (“UDP”), Global System for Mobile Communications (“GSM”) technologies, Code Division Multiple Access (“CDMA”) technologies, Time Division Multiple Access (“TDMA”) technologies, Short Message Service (“SMS”), Multimedia Message Service (“MMS”), radio frequency (“RF”) signaling technologies, Long Term Evolution (“LTE”) technologies, wireless communication technologies, in-band and out-of-band signaling technologies, and other suitable communications networks and technologies.

Communication infrastructure 1112 may include hardware, software, or both that couples components of computing device 1100 to each other. As an example and not by way of limitation, communication infrastructure 1112 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination thereof.

In the foregoing specification, the invention has been described with reference to specific example embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A computer-implemented method comprising:
detecting, from a digital image displayed by a client device, a text segment portrayed in accordance with a depth perspective of the digital image;
generating, within the digital image and from the text segment, an editable text object that follows the depth perspective of the digital image; and
modifying, in response to receiving one or more user interactions via the client device, the editable text object in accordance with the depth perspective of the digital image.

2. The computer-implemented method of claim 1, wherein detecting the text segment portrayed in accordance with the depth perspective of the digital image comprises detecting, utilizing an object detection model, a text region within a digital raster image, the text region comprising the text segment portrayed in accordance with the depth perspective of the digital image and a bounding box around the text region.

3. The computer-implemented method of claim 1, further comprising:
generating a three-dimensional mesh of the digital image based on a depth map of the digital image; and
generating a three-dimensional mesh structure by combining the three-dimensional mesh with the digital image,
wherein generating the editable text object that follows the depth perspective of the digital image comprises generating the editable text object from the three-dimensional mesh structure.

4. The computer-implemented method of claim 1, wherein generating the editable text object that follows the depth perspective of the digital image comprises:
generating, from the digital image, a two-dimensional representation of a text region that includes the text segment;
generating the editable text object from the two-dimensional representation of the text region; and
projecting the editable text object onto an underlying three-dimensional structure of the digital image.

5. The computer-implemented method of claim 4, wherein generating the two-dimensional representation of the text region comprises:
generating, utilizing a three-dimensional rendering engine, a rendered mesh of the digital image;
aligning a center of the text region with a camera view direction of the digital image; and
projecting the text region aligned with the camera view direction onto a two-dimensional surface.

6. The computer-implemented method of claim 4, wherein projecting the editable text object onto the underlying three-dimensional structure of the digital image comprises aligning, utilizing non-linear transformation, the editable text object with the underlying three-dimensional structure.

7. The computer-implemented method of claim 1, further comprising:
generating one or more content fills for the editable text object using an image completion model; and
exposing the one or more content fills upon modifying the editable text object.

8. A system comprising:
one or more memory devices; and
one or more processors configured to cause the system to:
generate a three-dimensional mesh structure from a digital raster image that portrays a text segment in accordance with a depth perspective;
flatten a text region comprising the text segment by projecting the text region onto a two-dimensional surface using the three-dimensional mesh structure;
generate, using an optical character recognition model and from the projected text region, an editable text object for the text segment;
modify the editable text object in response to receiving one or more user interactions via a client device portraying the digital raster image; and
project the modified editable text object onto the three-dimensional mesh structure to portray the modified editable text object in accordance with the depth perspective of the digital raster image.

9. The system of claim 8, wherein the one or more processors are further configured to detect the text segment portrayed in accordance with the depth perspective of the digital raster image by using an object detection model to generate one or more outputs that distinguish between one or more text regions of the digital raster image from one or more non-text regions of the digital raster image, wherein at least one text region comprises the text segment.

10. The system of claim 8, wherein the one or more processors are configured to cause the system to generate the three-dimensional mesh structure from the digital raster image based by:
generating, utilizing a depth detection machine learning model, a depth map of the digital raster image;
generating a three-dimensional mesh of the digital raster image from the depth map of the digital raster image; and
generating the three-dimensional mesh structure by combining the digital raster image with the three-dimensional mesh of the digital raster image.

11. The system of claim 10, wherein generating the three-dimensional mesh of the digital raster image from the depth map comprises:
extracting a set of sample points from the depth map of the digital raster image based on a depth variation of the depth map; and
generating a triangle mesh from the set of sample points.

12. The system of claim 8, wherein projecting the text region onto the two-dimensional surface using the three-dimensional mesh structure comprises:
determining one or more surface normals for a portion of the three-dimensional mesh structure corresponding to the text region;
adjusting an orientation of the three-dimensional mesh structure such that a center of the text region aligns with a camera view direction of the digital raster image; and
projecting, using a reverse texture mapping model, the text region aligned with the camera view direction onto the two-dimensional surface.

13. The system of claim 12,
further comprising determining, using a neural network, at least one camera property associated with the digital raster image,
wherein determining the one or more surface normals for the portion of the three-dimensional mesh structure comprises determining the one or more surface normals using the at least one camera property.

14. The system of claim 8, further comprising generating a modified digital raster image by repositioning the modified editable text object at a second region of the digital raster image that differs from the text region comprising the text segment in accordance with the depth perspective at the second region.

15. A non-transitory computer-readable medium storing executable instructions which, when executed by a processing device, cause the processing device to perform operations comprising:
detecting, from a digital image displayed by a client device, a text segment portrayed in accordance with a depth perspective of the digital image;
generating, within the digital image and from the text segment, an editable text object that follows the depth perspective of the digital image;
generating, using an image completion model, one or more content fills for the editable text object;
modifying, in response to receiving one or more user interactions via the client device, the editable text object in accordance with the depth perspective of the digital image, wherein modifying the editable text object exposes the one or more content fills.

16. The non-transitory computer-readable medium of claim 15, wherein detecting the text segment portrayed in accordance with the depth perspective of the digital image comprises detecting the text segment portrayed on an object of the digital image, the object following the depth perspective of the digital image.

17. The non-transitory computer-readable medium of claim 15, wherein generating the editable text object within the digital image comprises generating the editable text object within a raster digital image.

18. The non-transitory computer-readable medium of claim 15,
further comprising determining that the text segment is targeted for modification by determining that control point coordinates of input received via the client device intersect with a bounding box of a text region corresponding to the text segment,
wherein generating the editable text object from the text segment comprises generating the editable text object based on determining that the text segment is targeted for modification.

19. The non-transitory computer-readable medium of claim 18 wherein modifying the editable text object comprises modifying the editable text object via one or more transformation operations in accordance with the depth perspective of the digital image.

20. The non-transitory computer-readable medium of claim 15, further comprising determining a three-dimensional mesh structure of the digital image by:
generating, utilizing a machine learning model, a depth map of the digital image;
generating a three-dimensional mesh of the digital image based on the depth map of the digital image; and
mapping the digital image to the three-dimensional mesh,
wherein generating the editable text object from the text segment comprises generating the editable text object from the text segment using the three-dimensional mesh structure.
